(19) United States
(12) Patent Application Publication
(10) Pub. No.: US 2015/0001917 A1
(43) Pub. Date: Jan. 1, 2015

(54) BRAKE SYSTEM FOR VEHICLE DESIGNED TO FACILITATE ADJUSTMENT OF BRAKING HYSTERESIS

(71) Applicant: DENSO CORPORATION, Kariya-city (JP)

(72) Inventors: Takashi MURAYAMA, Kariya-shi (JP); Yasuhiro SASAKI, Okazaki-shi (JP); Takahiro YAMAGUCHI, Kariya-shi (JP); Junji ISHIMURA, Takahama-shi (JP); Atsushi SUZUKI, Kariya-shi (JP)

(21) Appl. No.: 14/315,813

(22) Filed: Jun. 26, 2014

(30) Foreign Application Priority Data
Jun. 28, 2013 (JP) 2013-137369

(51) Int. Cl. B60T 13/14; B60T 13/58; B60T 11/18

(52) U.S. Cl. CPC B60T 13/142; B60T 11/18; B60T 13/58
USPC 303/14

(57) ABSTRACT

A braking device for a vehicle is provided which includes a servo unit working to develop a hydraulic pressure which generates a braking force. The servo unit is actuated following movement of a movable member to develop the hydraulic pressure. The movable member moves in response to a braking effort. The braking device has an elastic member working to create resistance to the movement of the movable member relative, so that the resistance is different between when the movable member moves in a frontward direction and when the movable member moves in a backward direction. This produces a hysteresis in relation of the brake effort to the amount of movement of the movable member.

### CROSS REFERENCE TO RELATED DOCUMENT

The present application claims the benefit of priority of Japanese Patent Application No. 2013-137369 filed on Jun. 28, 2013, the disclosure of which is incorporated herein by reference.

### BACKGROUND OF THE INVENTION

1. Technical Field

This disclosure relates generally to a brake system for vehicles which works to control braking force applied to, for example, an automobile and is designed to facilitate adjustment of braking hysteresis.

2. Background Art

EP2212170 A2 teaches an automotive brake system designed to control braking force applied to a vehicle. The brake system is equipped with a brake simulator serving to simulate characteristics of a conventional brake system felt by a vehicle operator or driver at a brake pedal and a hydraulic booster serving to boost pressure in an accumulator to produce pressure in a master cylinder which is to be applied to a friction brake as a function of an operation of the brake pedal. Japanese Patent First Publication No. 2005-162127 teaches a brake-by-wire system for automotive vehicles.

The brake-by-wire system is equipped with a master cylinder which is equipped with a stroke simulator and a pressure regulator as discrete parts. The stroke simulator works to imitate the sense of depression of a brake pedal during a brake-by-wire braking operation. The pressure regulator works to regulate the pressure in an accumulator in which brake fluid is stored. In terms of structure of the brake-by-wire system, an operation mode of the master cylinder in which the pressure of brake fluid is increased is hardly different in characteristic from that in which the hydraulic pressure is decreased. There is, thus, still room for improvement on controllability of braking made by a driver of the vehicle. Specifically, the master cylinder usually connects with a brake pedal through an operating rod. The brake-by-wire system works to develop the pressure of brake fluid in response to stroke of the operating rod following depression of the brake pedal. The master cylinder is equipped with seals whose surface are subjected to pressure which rises when the operating rod moves frontward following the depression of the brake pedal in conventional brake systems other than the brake-by-wire system, thereby resulting in an increase in resistance to the depression of the brake pedal. The brake-by-wire system is not designed to increase the pressure exerted on the surfaces of the seals in response to the movement of the operating rod, thus resulting in less hysteresis in relation between a brake operating stroke (i.e., a stroke of the brake pedal) and a brake operating effort (i.e., the pressure produced by depression of the brake pedal). This causes a small change in the brake operating effort to be reflected in deceleration of the vehicle, thus resulting in increased difficulty in controlling the deceleration of the vehicle.

### SUMMARY

It is therefore an object to provide a brake device for vehicles which is designed as a brake-by-wire system and capable of adjusting the degree of braking hysteresis with a high degree of freedom.

According to one aspect of this disclosure, there is provided a braking device for a vehicle such as an automobile. The braking device comprises: (a) a hydraulic pressure generator which includes a master cylinder which has a given length with a front and a rear and in which a master piston and an input piston are disposed, the master cylinder having formed therein a master chamber in which the master piston is moved within the master cylinder in response to an operation on a brake actuating member to develop pressure of brake fluid; (b) a servo unit which works to develop a hydraulic pressure within a servo chamber as a function of the operation on the brake actuating member and exert force on the master piston as a function of the hydraulic pressure in the servo chamber; (c) a wheel cylinder to which the pressure of the brake fluid is delivered from the master chamber to develop a frictional braking force to brake a vehicle; (d) an operating rod which has a front portion and a rear portion, the front portion being closer to the front of the master cylinder than the rear portion is, the operating rod working to transmit a braking effort, as applied to the brake actuating member, to the input piston disposed in the master cylinder; (e) a first spring retainer which is of a hollow cylindrical shape and disposed around the front portion of the operating rod and away from an outer periphery of the operating rod; (f) a second spring retainer which is of a hollow cylindrical shape and disposed around an outer periphery of the rear portion of the operating rod; (g) a return spring which is disposed between the first spring retainer and the second spring retainer, the return spring urging the first spring retainer in a frontward direction of the master cylinder and also urging the second spring retainer in a rearward direction of the master cylinder; (h) a movable member which moves following the operation on the brake actuating member in one of a forward direction in which the movable member approaches the front of the master cylinder and a backward direction in which the movable member travels away from the front of the master cylinder; (i) an outer peripheral member which is disposed around an outer periphery of the movable member to be stationary relative to the movable member; and (j) an elastic member which is of a hollow cylindrical shape and installed between the movable member and the outer peripheral member to seal therebetween.

The servo unit is actuated following movement of the movable member to develop the hydraulic pressure within the servo chamber.

The elastic member works to create resistance to the movement of the movable member relative to the outer peripheral member and change the resistance following the movement of the movable member, so that the resistance is different between when the movable member moves in the frontward direction and when the movable member moves in the backward direction.

The resistance to the movement of the movable member relative to the outer peripheral member is, as described above, different between when the movable member moves in the frontward direction and when the movable member moves in the backward direction, thereby producing a hysteresis in relation of a brake operating effort, as transmitted to the servo unit through the movable member, to a brake operating stroke (i.e., an amount of movement of the movable member). The hysteresis may be set with a high degree of freedom by changing, for example, the modulus of elasticity of the elastic member.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a block diagram which illustrates a hybrid vehicle in which a braking device according to an embodiment is mounted;

FIG. 2 is a partially longitudinal sectional view which illustrates the braking device of FIG. 1;

FIG. 3(a) is a front view of a support member installed in a hydraulic booster of the braking device of FIG. 2;

FIG. 3(b) is a side view of FIG. 3(a);

FIG. 4 is an enlarged view of a spool piston and a spool cylinder of a hydraulic booster of the braking device of FIG. 2 in a pressure-reducing mode;

FIG. 5 is a graph which represents a relation between a braking effort acting on a brake pedal and a braking force;

FIG. 6 is an enlarged view of a spool piston and a spool cylinder of a hydraulic booster of the braking device of FIG. 2 in a pressure-increasing mode;

FIG. 7 is an enlarged view of a spool piston and a spool cylinder of a hydraulic booster of the braking device of FIG. 2 in a pressure-holding mode;

FIG. 8 is a graph which represents a relation between an amount of stroke of a brake pedal and a reactive force exerted on the brake pedal in response to depression of the brake pedal;

FIG. 9 is a partially enlarged view of a rear portion of a hydraulic booster of the braking device of FIG. 2;

FIG. 10 is a partially longitudinal sectional view which illustrates a sealing member which gradually increases a mechanical resistance to frontward movement of an input piston;

FIG. 11 is a partially longitudinal sectional view which illustrates a centering member working to center an operating rod installed in a hydraulic booster of the braking device of FIG. 2;

FIG. 12 is a partially longitudinal sectional view which illustrates a boot cover installed on a rear portion of a hydraulic booster of the braking device of FIG. 2;

FIG. 13 is a partially enlarged view of FIG. 12;

FIG. 14 is a partially longitudinal sectional view which illustrates a sealing member which gradually increases a mechanical resistance to frontward movement of an input piston of a hydraulic booster of the second embodiment;

FIG. 15 is a partially longitudinal sectional view which illustrates a modification of the sealing member of FIG. 14; and

FIG. 16 is a partially longitudinal sectional view which illustrates a sealing member which gradually increases a mechanical resistance to frontward movement of an input piston of a hydraulic booster of the third embodiment.

### DESCRIPTION OF THE PREFERRED EMBODIMENTS

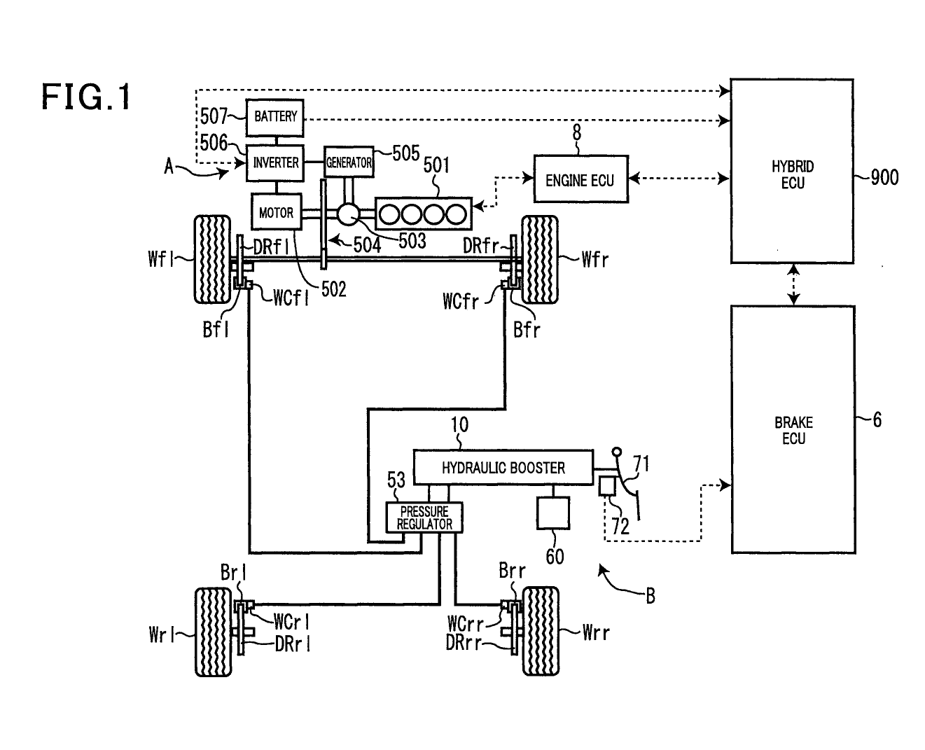

Referring to the drawings, wherein like reference numbers refer to like parts in several views, particularly to FIG. 1, there is shown a brake system B for vehicles such as automobiles according to an embodiment. The drawings are merely schematic views which do not necessarily illustrate dimensions of parts of the brake system B precisely.

### Hybrid Vehicle

The brake system B, as referred to herein, is engineered as a friction brake unit mounted in a hybrid vehicle. The hybrid vehicle is equipped with a hybrid system to drive wheels, for example, front left and right wheels Wfl and Wfr. The hybrid vehicle also includes a brake ECU (Electronic Control Unit) 6, an engine ECU (Electronic Control Unit) 8, a hybrid ECU (Electronic Control Unit) 900, a hydraulic booster 10, a pressure regulator 53, a hydraulic pressure generator 60, a brake pedal (i.e., a brake actuating member) 71, a brake sensor 72, an internal combustion engine 501, an electric motor 502, a power split device 503, a power transmission device 504, an inverter 506, and a storage battery 507.

The output power of the engine 501 is transmitted to the driven wheels through the power split device 503 and the power transmission device 504. The output power of the motor 502 is also transmitted to the driven wheels through the power transmission device 504.

The inverter 506 works to achieve conversion of voltage between the motor 502 or an electric generator 505 and the battery 507. The engine ECU 8 works to receives instructions from the hybrid ECU 900 to control the power, as outputted from the engine 501. The hybrid ECU 900 serves to control operations of the motor 502 and the generator 505 through the inverter 506. The hybrid ECU 900 is connected to the battery 507 and monitors the state of charge (SOC) of and current charged in the battery 507.

A combination of the generator 505, the inverter 506, and the battery 507 makes a regenerative braking system A. The regenerative braking system A works to make the wheel Wfl and Wfr produce a regenerative braking force as a function of an actually producible regenerative braking force, which will be described later in detail. The motor 502 and the generator 505 are illustrated in FIG. 1 as being separate parts, but their operations may be achieved by a single motor/generator.

Friction braking devices Bfl, Bfr, Brl, and Brr are disposed near the wheels Wfl, Wfr, Wrl, and Wrr of the vehicle. The friction braking device Bfl includes a brake disc DRfl and a brake pad (not shown). The brake disc DRfl rotates along with the wheel Wfl. The brake pad is of a typical type and pressed against the brake disc DRfl to produce a friction braking power. Similarly, the friction braking devices Bfr, Brl, and Brr are made up of brake discs DRfl, DRfr, DRrl, and DRrr and brake pads (not shown), respectively, and identical in operation and structure with the friction braking device Bfl. The explanation thereof in detail will be omitted here. The friction braking devices Bfl, Bfr, Brl, and Brr also include wheel cylinders WCfl, WCfr, WCrl, and WCrr, respectively, which are responsive to a master pressure (which is also called master cylinder pressure) that is hydraulic pressure, as developed by the hydraulic booster 10, required to press the brake pads against the brake discs DRfl, DRfr, DRrl, and DRrr, respectively.

The brake sensor 72 measures the amount of stroke, or position of the brake pedal 71 depressed by the vehicle operator or driver and outputs a signal indicative thereof to the brake ECU 6. The brake ECU 6 calculates a braking force, as required by the vehicle driver, as a function of the signal outputted from the brake sensor 72. The brake ECU 6 calculates a target regenerative braking force as a function of the required braking force and outputs a signal indicative of the target regenerative braking force to the hybrid ECU 900. The hybrid ECU 900 calculates the actually producible regenerative braking force as a function of the target regenerative braking force and outputs a signal indicative thereof to the brake ECU 6.

### Hydraulic Pressure Generator

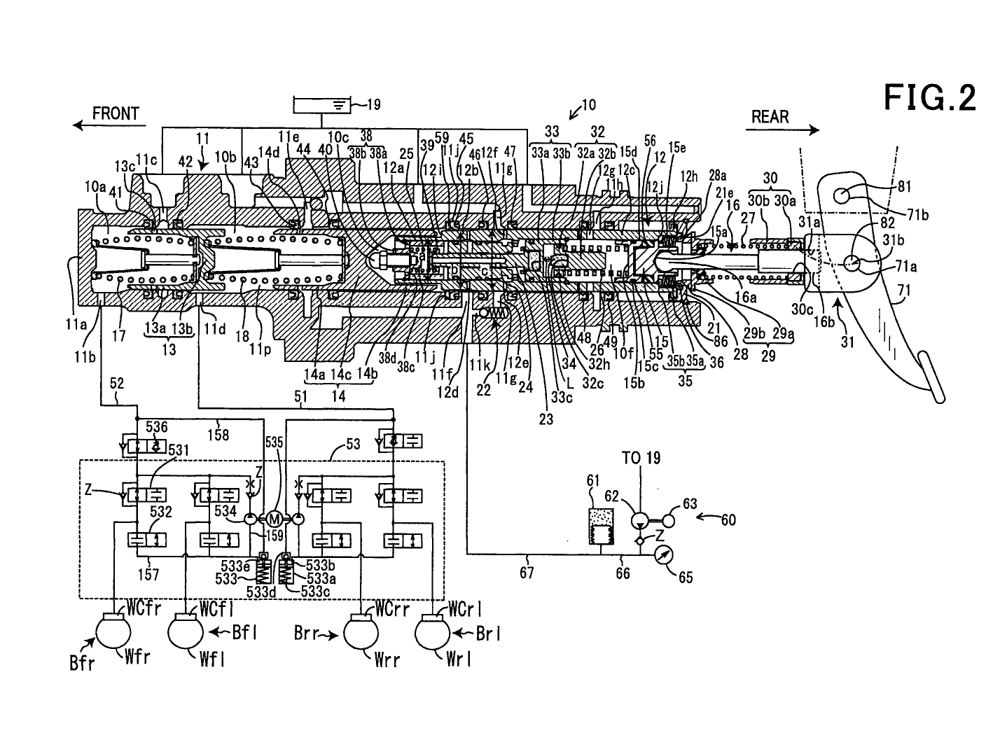

The structure and operation of the hydraulic pressure generator 60 will be described in detail with reference to FIG. 2. The hydraulic pressure generator 60 works to produce an accumulator pressure and includes an accumulator 61, a hydraulic pressure pump 62, and a pressure sensor 65.

The accumulator 61 stores therein brake fluid under pressure. Specifically, the accumulator 61 stores accumulator pressure that is the hydraulic pressure of the brake fluid, as created by the hydraulic pressure pump 62. The accumulator 61 connects with the pressure sensor 65 and the hydraulic pressure pump 62 through a pipe 66. The hydraulic pressure pump 62 connects with a reservoir 19. The hydraulic pressure pump 62 is driven by an electric motor 63 to deliver the brake fluid from the reservoir 19 to the accumulator 61.

The pressure sensor 65 works to measure the accumulator pressure that is the pressure in the accumulator 61. When the accumulator pressure is determined through the pressure sensor 65 to have dropped below a given value, the brake ECU 6 outputs a control signal to actuate the motor 63. The hydraulic pressure generator 60, the spool piston 23, and the spool cylinder 24 of the hydraulic booster 10 constitute a servo unit which works to generate a hydraulic pressure in a servo chamber 10c (which will be described later in detail) as a function of the braking effort on the brake pedal 71 and exert force on a master piston (which will be described later in detail) as a function of the hydraulic pressure in the servo chamber 10c.

### Hydraulic Booster

The structure and operation of the hydraulic booster 10 will be described below with reference to FIG. 2. The hydraulic booster 10 works as a hydraulic pressure generator to regulate the accumulator pressure, as developed by the hydraulic pressure generator 60, as a function of the stroke of (i.e., a driver's effort on) the brake pedal 71 to generate a servo pressure which is, in turn, used to generate the master pressure.

The hydraulic booster 10 includes a master cylinder 11, a fail-safe cylinder 12, a first master piston 13, a second master piston 14, an input piston 15, an operating rod 16, a first return spring 17, a second return spring 18, a reservoir 19, a stopper 21, a mechanical relief valve 22, a spool piston 23, a spool cylinder 24, a spool spring 25, a simulator spring 26, a pedal return spring 27, a movable member 28, a first spring retainer 29, a second spring retainer 30, a connecting member 31, a movable member 32, a retaining piston 33, a simulator rubber 34 serving as a cushion, a spring retainer 35, a fail-safe spring 36, a damper 37, a first spool spring retainer 38, a second spring retainer 39, a pushing member 40, and sealing members 41 to 49.

In the following discussion, a part of the hydraulic booster 10 where the first master piston 13 is disposed will be referred to as the front of the hydraulic booster 10, while a part of the hydraulic booster 10 where the operating rod 16 is disposed will be referred to as the rear of the hydraulic booster 10. An axial direction (i.e., a lengthwise direction) of the hydraulic booster 10, thus, represents a front-back direction of the hydraulic booster 10.

The master cylinder 11 is of a hollow cylindrical shape which has a bottom 11a on the front of the hydraulic booster 10 and an opening defining the rear of the hydraulic booster 10. The master cylinder 11 has a given length aligned with the length of the hydraulic booster 10, a front end (i.e. the bottom 11a), and a rear end (i.e., the opening) at the rear of the hydraulic booster 10. The master cylinder 11 also has a cylindrical cavity 11p extending in the lengthwise or longitudinal direction thereof. The master cylinder 11 is installed in the vehicle. The master cylinder 11 has a first port 11b, a second port 11c, a third port 11d, a fourth port 11e, a fifth port 11f (i.e., a supply port), a sixth port 11g, and a seventh port 11h all of which communicate with the cylindrical cavity 11p and which are arranged in that order from the front to the rear of the master cylinder 11. The second port 11c, the fourth port 11e, the sixth port 11g, and the seventh port 11h connect with the reservoir 19 in which the brake fluid is stored. The reservoir 19, thus, communicates with the cylindrical cavity 11p of the master cylinder 11.

The sealing members 41 and 42 are disposed in annular grooves formed in an inner peripheral wall of the master cylinder 11 across the second port 11c. The sealing members 41 and 42 are in hermetic contact with an entire outer circumference of the first master piston 13. Similarly, the sealing members 43 and 44 are disposed in annular grooves formed in the inner peripheral wall of the master cylinder 11 across the fourth port 11e. The sealing members 43 and 44 are in hermetic contact with an entire outer circumference of the second master piston 14.

The sealing members 45 and 46 are disposed in annular grooves formed in the inner peripheral wall of the master cylinder 11 across the fifth port 11f. The sealing members 45 and 46 are in hermetic contact with entire outer circumferences of a first cylindrical portion 12b and a second cylindrical portion 12c of the fail-safe cylinder 12, as will be described later in detail. The sealing member 47 is disposed in an annular groove formed in the inner peripheral wall of the master cylinder 11 behind the sealing member 46 in hermetic contact with the entire outer circumference of the second cylindrical portion 12c. Similarly, the sealing members 48 and 49 are disposed in annular grooves formed in the inner peripheral wall of the master cylinder 11 across the seventh port 11h. The sealing members 48 and 49 are in hermetic contact with the entire outer circumference of the second cylindrical portion 12c of the fail-safe cylinder 12.

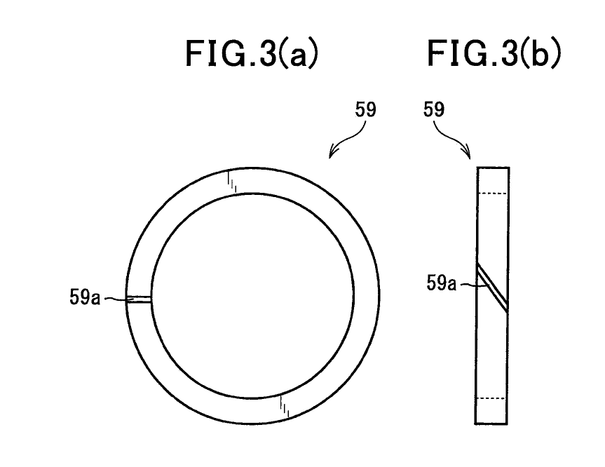

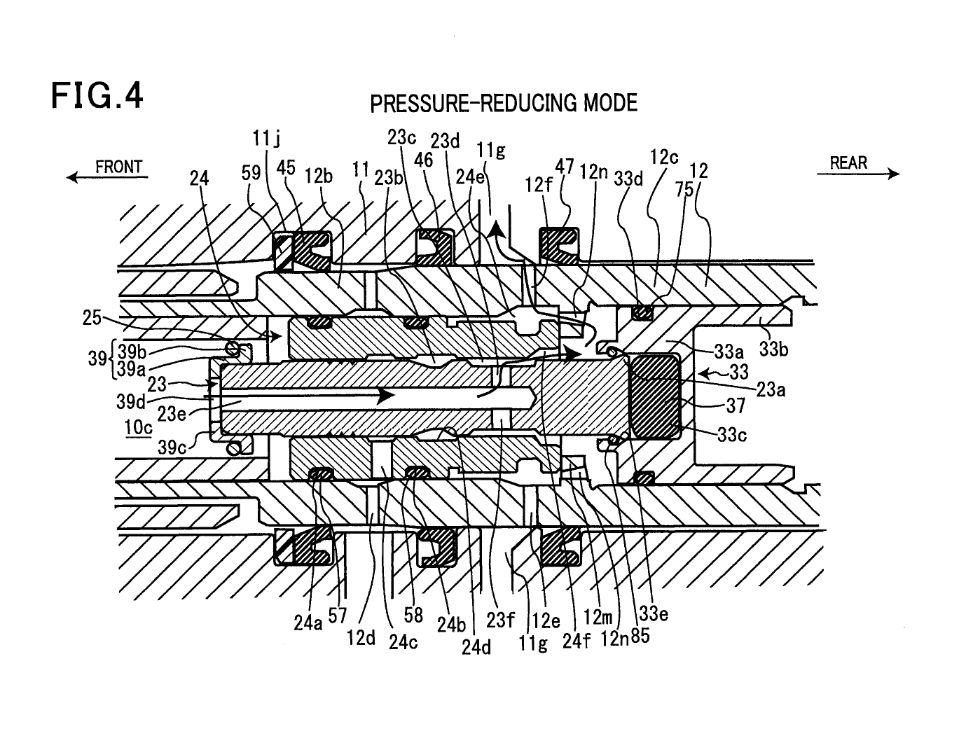

A support member 59 is disposed on the front surface of the sealing member 45. The sealing member 45 and the support member 59 are installed in a common retaining groove 11j formed in the inner wall of the master cylinder 11. The sealing member 45 and the support member 59 are, as clearly illustrated in FIG. 4, placed in abutment contact with each other. The support member 59 is, as illustrated in FIGS. 3(a) and 3(b), of a ring shape and has a slit 59a formed therein. The support member 59 is made of elastic material such as resin and has an inner peripheral surface in contact with the outer circumferential surface of the first cylindrical portion 12b of the fail-safe cylinder 12 which will be described later in detail.

Referring back to FIG. 2, the fifth port 11f works as a supply port establishes a fluid communication between the outer periphery of the master cylinder 11 and the cylindrical cavity 11p. The fifth port 11f connects with the accumulator 61 through a pipe 67. In other words, the accumulator 61 communicates with the cylindrical cavity 11p of the master cylinder 11, so that the accumulator pressure is supplied to the fifth port 11f.

The fifth port 11f and the sixth port 11g communicate with each other through a connecting fluid path 11k in which a mechanical relief valve 22 is mounted. The mechanical relief valve 22 works to block a flow of the brake fluid from the sixth port 11g to the fifth port 11f and allow a flow of the brake fluid from the fifth port 11f to the sixth port 11g when the pressure in the fifth port 11f rises above a given level.

An assembly of the first master piston 13 and the second master piston 14 serves as a master piston of the brake system B. The first master piston 13 is disposed in a front portion of the cylindrical cavity 11p of the master cylinder 11, that is, located behind the bottom 11a, so that it is slidable in the longitudinal direction of the cylindrical cavity 11p. The first master piston 13 is of a bottomed cylindrical shape and made up of a hollow cylindrical portion 13a and a cup-shaped retaining portion 13b extending behind the cylindrical portion 13a. The retaining portion 13b is fluidly isolated from the cylindrical portion 13a. The cylindrical portion 13a has fluid holes 13c formed therein. The cylindrical cavity 11p includes a first master chamber 10a located in front of the retaining portion 13b. Specifically, the first master cylinder 10a is defined by the inner wall of the master cylinder 11, the cylindrical portion 13a, and the retaining portion 13b. The first port 11b communicates with the first master chamber 10a. The first master chamber 10a is filled with the brake fluid which is supplied to the wheel cylinders WCfl, WCfr, WCrl, and WCrr.

The first return spring 17 is disposed between the bottom 11a of the master cylinder 11 and the retaining portion of the first master piston 13. The first return spring 17 urges the first master piston 13 backward to place the first master piston 13 at an initial position, as illustrated in FIG. 2, unless the brake pedal 71 is depressed by the vehicle driver.

When the first master piston 13 is in the initial position, the second port 11c coincides or communicates with the fluid holes 13c, so that the reservoir 19 communicates with the first master chamber 10a. This causes the brake fluid to be delivered from the reservoir 19 to the first master chamber 10a. An excess of the brake fluid in the first master chamber 10a is returned back to the reservoir 19. When the first master piston 13 travels frontward from the initial position, it will cause the second port 11c to be blocked by the cylindrical portion 13a, so that the first master chamber 10a is closed hermetically to create the master pressure therein.

The second master piston 14 is disposed in a rear portion of the cylindrical cavity 11p of the master cylinder 11, that is, located behind the first master piston 13, so that it is slidable in the longitudinal direction of the cylindrical cavity 11p. The second master piston 14 is made up of a first cylindrical portion 14a, a second cylindrical portion 14b lying behind the first cylindrical portion 14a, and a retaining portion 14c formed between the first and second cylindrical portions 14a and 14b. The retaining portion 14c fluidly isolates the first and second cylindrical portions 14a and 14b from each other. The first cylindrical portion 14a has fluid holes 14d formed therein.

The cylindrical cavity 11p includes a second master chamber 10b located in front of the retaining portion 14b. Specifically, the second master cylinder 10b is defined by the inner wall of the master cylinder 11, the first cylindrical portion 14a, and the retaining portion 14c. The third port 11d communicates with the second master chamber 10b. The second master chamber 10b is filled with the brake fluid which is supplied to the wheel cylinders WCfl, WCfr, WCrl, and WCrr. The second master chamber 10b defines a master chamber within the cylindrical cavity 11p along with the first master chamber 10a.

The second return spring 18 is disposed between the retaining portion 13 of the first master piston 13 and the retaining portion 14c of the second master piston 14. The second return spring 18 is greater in set load than the first return spring 17. The second return spring 18 urges the second master piston 14 backward to place the second master piston 14 at an initial position, as illustrated in FIG. 2, unless the brake pedal 71 is depressed by the vehicle driver.

When the second master piston 14 is in the initial position, the fourth port 11e coincides or communicates with the fluid holes 14d, so that the reservoir 19 communicates with the second master chamber 10b. This causes the brake fluid to be delivered from the reservoir 19 to the second master chamber 10b. An excess of the brake fluid in the second master chamber 10b is returned back to the reservoir 19. When the second master piston 14 travels frontward from the initial position, it will cause the fourth port 11e to be blocked by the cylindrical portion 14a, so that the second master chamber 10b is closed hermetically to create the master pressure therein.

The fail-safe cylinder 12 is disposed behind the second master piston 14 within the cylindrical cavity 11p of the master cylinder 11 to be slidable in the longitudinal direction of the cylindrical cavity 11p. The fail-safe cylinder 12 is made up of the front cylindrical portion 12a, the first cylindrical portion 12b, and the second cylindrical portion 12c which are aligned with each other in the lengthwise direction thereof. The front cylindrical portion 12a, the first cylindrical portion 12b, and the second cylindrical portion 12c are formed integrally with each other and all of a hollow cylindrical shape. The front cylindrical portion 12a has an outer diameter a. The first cylindrical portion 12b has an outer diameter b which is greater than the outer diameter a of the front cylindrical portion 12a. The second cylindrical portion 12c has an outer diameter c which is greater than the outer diameter b of the first cylindrical portion 12b. The fail-safe cylinder 12 has an outer shoulder formed between the front cylindrical portion 12a and the first cylindrical portion 12b to define a pressing surface 12i.

The second cylindrical portion 12c has a flange 12h extending outward from a rear end thereof. The flange 12h contacts with the stopper 21 to stop the fail-safe cylinder 12 from moving outside the master cylinder 11. The second cylindrical portion 12c has a rear end formed to be greater in inner diameter than another portion thereof to define an inner shoulder 12j.

The front cylindrical portion 12a is disposed inside the second cylindrical portion 14b of the second master piston 14. The first cylindrical portion 12b has first inner ports 12d formed in a rear portion thereof. The first inner ports 12d communicate between the outer peripheral surface and the inner peripheral surface of the first cylindrical portion 12b, in other words, passes through the thickness of the first cylindrical portion 12b. The second cylindrical portion 12c has formed in a front portion thereof a second inner port 12e and a third inner port 12f which extend through the thickness of the second cylindrical portion 12c. The second cylindrical portion 12c also has fourth inner ports 12g formed in a middle portion thereof. The fourth inner ports 12g extend through the thickness of the second cylindrical portion 12c and opens toward the front end (i.e., the head) of the input piston 15 disposed within the fail-safe cylinder 12.

The second cylindrical portion 12c, as illustrated in FIG. 4, has a stopper 12m formed on a front inner peripheral wall thereof. The stopper 12m has formed therein fluid flow paths 12n extending in the longitudinal direction of the second cylindrical portion 12c.

The input piston 15 is, as clearly illustrated in FIG. 2, located behind the spool cylinder 24 and the spool piston 23, which will be described later in detail, to be slidable in the longitudinal direction thereof within a rear portion of the second cylindrical portion 12c of the fail-safe cylinder 12 (i.e., the cylindrical cavity 11p). The input piston 15 is made of a cylindrical member and substantially circular in cross section thereof. The input piston 15 has a rod-retaining chamber 15a formed in a rear end thereof. The rod-retaining chamber 15a has a conical bottom. The input piston 15 also has a spring-retaining chamber 15b formed in a front end thereof. The input piston 15 has an outer shoulder 15e to have a small-diameter rear portion which is smaller in outer diameter than a major portion thereof.

The input piston 15 has seal retaining grooves (i.e., recesses) 15c and 15d formed in an outer periphery thereof. Sealing members 55 and 56 are disposed in the seal retaining grooves 15c and 15d in hermetical contact with an entire inner circumference of the second cylindrical portion 12c of the fail-safe cylinder 12. The seal retaining grooves 15c and 15d may alternatively be formed in the fail-safe cylinder 12.

The input piston 15 is coupled with the brake pedal 71 through the operating rod 16 and a connecting member 31, so that the effort acting on the brake pedal 71 is transmitted to the input piston 15. The input piston 15 works to transmit the effort, as exerted thereon, to the spool piston 23 through the simulator spring 26, the movable member 32, the simulator rubber 34, the retaining piston 33, and the damper 37, so that the spool piston 23 travels in the longitudinal direction thereof. The structure of the input piston 15 will be described later in detail.

### Structure of Rear of Hydraulic Booster

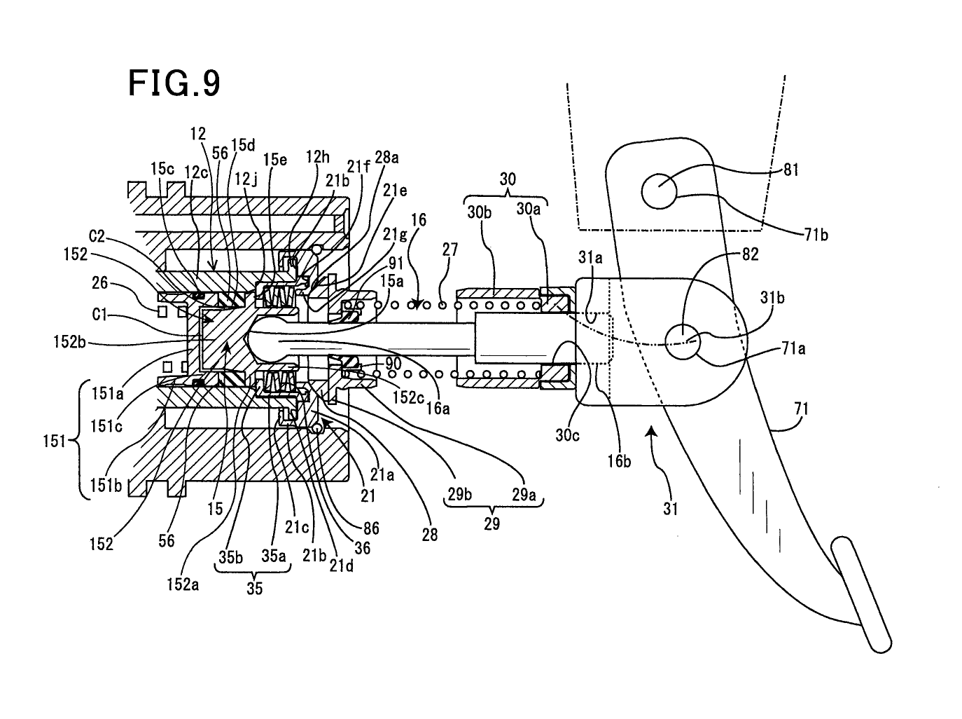

Referring to FIG. 9, the spring retainer 35 is made up of a hollow cylinder 35a and a ring-shaped support 35b extending inwardly from a front edge of the hollow cylinder 35a. The spring retainer 35 is fit in the rear end of the second cylindrical portion 12c with the support 35b having the front surface thereof placed in contact with the shoulder 15e of the input piston 15.

The stopper 21 is attached to the inner wall of the rear end of the master cylinder 11 to be movable. The stopper 21 is designed as a stopper plate and made up of a ring-shaped base 21a, a hollow cylinder 21b, and a stopper ring 21c. The hollow cylinder 21b extends forward from the front end of the base 21a. The stopper ring 21c extends inwardly from the front end of the hollow cylinder 21b.

The base 21a has a front surface 21d which lies inside the hollow cylinder 21b as a support surface with which the rear end (i.e., the flange 12h) of the fail-safe cylinder 12 is placed in contact. The flange 12h will also be referred to as a contact portion below. The stopper 21 also includes a ring-shaped retaining recess 21f formed in the front surface of the base 21a inside the support surface 21d in the shape of a groove. Within the retaining recess 21f, the rear end of the cylinder 35a of the spring retainer 35 is fit. The stopper 21 further includes a ring-shaped protrusion 21g extending from the front of the base 21a inside the retaining recess 21f.

The base 21a has a domed recess 21e formed on a central area of the rear end thereof. The recess 21e serves as a seat and is of an arc or circular shape in cross section. The recess 21e will also be referred to as a seat below. The master cylinder 11 has a C-ring 86 fit in a groove formed in the inner wall of the open rear end thereof. The C-ring 86 works as a stopper to hold the stopper 21 from being removed from the master cylinder 11.

The movable member 28 is used as a spacer and made of a ring-shaped member. The movable member 28 has a front surface which is oriented toward the front of the master cylinder 11 and defines a convex or dome-shaped pressing surface 28a. The pressure surface 28a is of an arc or circular shape in cross section. The pressing surface 28a is contoured to conform with the shape of the seat 21e. The movable member 28 is disposed on the front end of the first spring retainer 29 which faces the front of the master cylinder 11. The movable member 28 is also arranged behind the stopper 21 with the pressing surface 28a being placed in slidable contact with the seat 21e. The movable member 28 is movable or slidable on the stopper 21 (i.e., the seat 21e).

The fail-safe spring 36 is disposed between the support 35b of the spring retainer 35 and the protrusion 21g of the stopper 21 within the cylinder 35a of the spring retainer 35. The fail-safe spring 36 is made up of a plurality of diaphragm springs and works to urge the fail-safe cylinder 12 forward against the master cylinder 11.

The first spring retainer 29 (which will also be referred to as a first retainer below) is made up of a hollow cylinder 29a and a flange 29b extending from the front end of the hollow cylinder 29a inwardly and outwardly. The first spring retainer 29 serves as a spring holder. The first spring 29 is arranged behind the movable member 28 with the flange 29b placed in abutment contact with the rear end of the movable member 28.

The operating rod 16 has a given length made up of a front portion around which first spring retainer 29 is disposed and a rear portion around which the second spring retainer 30 is disposed. The front portion is closer to the front of the master cylinder 11 than the rear portion is. The operating rod 16 has a pressing ball 16a formed on the front end thereof and a screw 16b formed on the rear end thereof. The operating rod 16 is joined to the rear end of the input piston 15 with the pressing ball 16a fit in the rod-retaining chamber 15a. The operating rod 16 has a given length extending in the longitudinal direction of the hydraulic booster 10. Specifically, the operating rod 16 has the length aligned with the length of the hydraulic booster 10. The operating rod 16 passes through the movable member 28 and the first spring retainer 29.

The second spring retainer 30 (which will also be referred to as a second retainer below) is disposed behind the first spring retainer 29 in alignment therewith and secured to the rear portion of the operating rod 16. The second spring retainer 30 is of a hollow cylindrical shape and made up of an annular bottom 30a and a cylinder 30b extending from the bottom 30a frontward. The bottom 30a has a threaded hole 30c into which the screw 16b of the operating rod 16 is fastened.

The pedal return spring 27 is disposed between the flange 29b of the first spring retainer 29 and the bottom 30a of the second spring retainer 30 so as to elastically urge the first spring retainer 29 in the frontward direction of the master cylinder 11 (i.e., the hydraulic booster 10) and also elastically urge the second spring retainer 30 in the rearward direction of the master cylinder 11. The pedal return spring 27 is held inside the cylinder 29a of the first spring retainer 29 and the cylinder 30b of the second spring retainer 30. The pedal return spring 27 works to urge the pressing surface 28a of the movable member 28 against the seat 21e of the stopper 21 through the first spring retainer 29.

The connecting member 31 has a threaded hole 31a formed in the front end thereof. The screw 16b of the operating rod 16 is fastened into the threaded hole 31a to join the connecting member 31 to the rear end of the operating rod 16. The bottom 30a of the second spring retainer 30 is in contact with the front end of the connecting member 31. The connecting member 31 has an axial through hole 31b formed in substantially the center thereof in the longitudinal direction of the hydraulic booster 10. The threaded hole 30c of the second spring retainer 30 and the threaded hole 31a of the connecting member 31 are in engagement with the screw 16b of the operating rod 16, thereby enabling the connecting member 31 to be regulated in position thereof relative to the operating rod 16 in the longitudinal direction of the operating rod 16.

The brake pedal 71 is made of a lever on which an effort is exerted by the driver of the vehicle. The brake pedal 71 has an axial hole 71a formed in the center thereof and a mount hole 71b formed in an upper portion thereof. A bolt 81 is inserted into the mount hole 71b to secure the brake pedal 71 to a mount base of the vehicle, as indicated by a broken line in FIG. 2. The brake pedal 71 is swingable about the bolt 81. A connecting pin 82 is inserted into the axial hole 71a of the brake pedal 71 and the axial hole 31b of the connecting member 31, so that the swinging motion of the brake pedal 71 is converted into linear motion of the connecting member 31.

The pedal return spring 27 urges the second spring retainer 30 and the connecting member 31 backward to keep the brake pedal at the initial position, as illustrated in FIG. 2. The depression of the brake pedal 71 will cause the brake pedal 71 to swing about the mount hole 71b (i.e., the bolt 81) and also cause the axial holes 71a and 31b to swing about the mount hole 71b. A two-dot chain line in FIG. 2 indicates a path of travel of the axial holes 71a and 31b. Specifically, when the brake pedal 71 is depressed, the axial holes 71a and 31b move upward along the two-dot chain line. This movement causes the movable member 28 and the first spring retainer 29 to swing or slide on the stopper 21 to prevent an excessive pressure (i.e., shearing force) from acting on the pedal return spring 27.

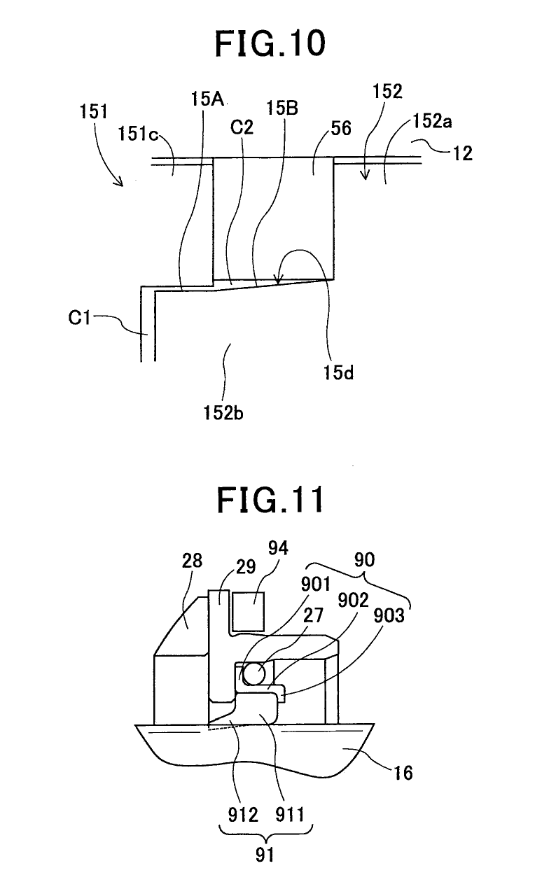

The input piston 15 functions as a movable member and is, as illustrated in FIGS. 9 and 10, made by an assembly of two discrete parts: a first input piston 151 (which will also be referred to as a first movable member) and a second input piston 152 (which will also be referred to as a second movable member). The first input piston 151 is made up of a disc-shaped base 151a, a first cylinder 151b, and a second cylinder 151c. The base 151a has a front end facing the front of the hydraulic booster 10 and a rear end facing the rear of the hydraulic booster 10. The first cylinder 151b is of a hollow shape and extends forward from a peripheral edge of the front end of the base 151a. the second cylinder 151c is of a hollow shape and extends rearward from a peripheral edge of the rear end of the base 151a. The base 151a and the first cylinder 151b define a front recess or chamber. The simulator spring 26 is placed in direct contact with the bottom of the front chamber, that is, the front end of the base 151a. Similarly, the base 151a and the second cylinder 151c define a rear recess or chamber. The second input piston 152, as described later in detail, has a protrusion 152b fit in the rear chamber. The second cylinder 151c has the seal retaining groove 15c formed in an outer circumference thereof.

The second input piston 152 defines a rear portion of the input piston 15. The second input piston 152 is made up of a disc-shaped base 152a, the protrusion 152b, and a hollow cylinder 152c. The base 152a has a front end facing the front of the hydraulic booster 10 and a rear end facing the rear of the hydraulic booster 10. The protrusion 152b extends frontward from a central area of the front end of the base 152a. The cylinder 152c extends rearward from a central area of the rear end of the base 152a in alignment with the protrusion 152b. The protrusion 152b has a top end portion inserted into the rear chamber of the first input piston 151. An air gap C1 exists between the front end of the protrusion 152b and the rear end of the base 151a. The seal retaining groove 15d is formed between the first input piston 151 and the second input piston 152. Specifically, the seal retaining groove 15d is defined by the rear end of the second cylinder 151c of the first input piston 151 and a peripheral portion (i.e., a shoulder) of the front end of the base 152a of the second input piston 152. The rod-retaining chamber 15a is formed by the base 152a and the cylinder 152c. The base 152a has a shoulder 15e formed on a peripheral portion of the rear end thereof around the circumference of the cylinder 152c.

The protrusion 152b has an outer peripheral surface made up of a front surface 15A and a slant surface 15B. The front surface 15A extends parallel to an axial direction (i.e., a longitudinal center line) of the protrusion 152b and is fit in the rear chamber of the first input piston 151. The slant surface 15B extends rearward from the front surface 15A and tapers to the front surface 15A. In other words, the outer diameter of the slant surface 15B decreases toward the front surface 15A. The slant surface 15B is, as can be seen from the above discussion, oriented at a given angle to a path along which the input piston 15 travels, in other words, in a longitudinal direction (i.e., an axial direction) of the input piston 15 (i.e., the master cylinder 11 or the fail-safe cylinder 12). The slant surface 15B defines a bottom surface of the seal retaining groove 15d.

The sealing member 56 works as an elastic member to create a hermetic seal between the input piston 15 and the fail-safe cylinder 12 and also produce, as will be described later in detail, variable friction therebetween. The sealing member 56 is of a ring-shape with a rectangular or square transverse section, as taken in the axial direction of the sealing member 56. The sealing member 56 is fit in the seal retaining groove 15d which has a slant bottom surface (i.e., the slant surface 15B). The sealing member 56 has a front surface placed in abutment with the second cylinder 151c and a rear surface placed in abutment with the front end of the base 152a. The sealing member 56 has an outer peripheral surface which is in abutment with an inner peripheral surface of the fail-safe cylinder 12. The fail-safe cylinder 12 will also be referred to below as an outer peripheral member which is stationary relative to the input piston 15 (i.e., the movable member). The sealing member 56 has an inner peripheral surface which has a rear edge placed in abutment with the slant surface 15B and a remaining area located away from the slant surface 15B when the brake pedal 71 is in the initial position. Specifically, when the brake pedal 71 is not depressed, an air gap C2 exists between the inner peripheral surface of the sealing member 56 other than the rear edge thereof and the slant surface 15B. The interval (i.e., the air gap C2) between the sealing member 56 and the slant surface 15B increases toward the front of the sealing member 56.

### Operation and Effect of Sealing Member 56

When the input piston 15 advances, that is, moves toward the front of the master cylinder 11 (i.e., the front of the hydraulic booster 10), the second input piston 152 moves to the first input piston 151 while elastically pressing the sealing member 56 so that it is elastically deformed until the air gap C1 disappears. The sealing member 56 works to transmit the pressure, as inputted thereto from the second input piston 152, to the first input piston 151 to push the first input piston 151 frontward. The sealing member 56 is elastically deformed by the pressure, as exerted by the second input piston 152, so that it bulges into the air gap C2. This causes the sealing member 56 to have an increasing area of contact with the slant surface 15B. In other words, the area of contact between the sealing member 56 and the slant surface 15B increases gradually as the second input piston 152 advances, that is, the braking effort required for the driver of the vehicle to depress on the brake pedal 71 increases. The increase in the area of contact of the sealing member 56 with the slant surface 15B will cause an overall surface pressure acting on the slant surface 15B (i.e., the second input piston 152) to increase, thus resulting in an increase in pressure exerted by the outer peripheral surface of the sealing member 56 on the inner peripheral surface of the fail-safe cylinder 12. This leads to an increase in resistance to sliding motion of the second piston 152 (i.e., the forward movement of the input piston 15).

When the input piston 15 moves backward away from the front of the master cylinder 11 (i.e., the front of the hydraulic booster 10), the resistance to the movement thereof is decreased by an amount equivalent to a portion of the sealing member 56 which has elastically bulged into the air gap C2, that is, a decrease in area of contact of the inner peripheral surface of the sealing member 56 with the slant surface 15B of the seal retaining groove 15d (i.e., a drop in pressure exerted by the outer peripheral surface of the sealing member 56 on the inner peripheral surface of the fail-safe cylinder 12). Thus, the resistance, as developed by the sealing member 56, to the backward movement of the input piston 15 (i.e., the second piston 152) will be lower than that to the frontward movement of the input piston 15. In other words, there is a hysteresis in relation of a brake operating effort (i.e., the pressure developed by depression of the brake pedal 71 and transmitted from the brake pedal 71 to the first input piston 151 (i.e., the simulator spring 26) through the second input piston 152, that is, force acting on the servo unit to develop the braking force, to a brake operating stroke (i.e., an amount of stroke of the input piston 15, in other words, an amount of stroke of the operating rod 16 or the brake pedal 71).

### Internal Structure of Rear of Hydraulic Booster

The operating rod 16, as illustrated in FIG. 9, has formed on the front end thereof the pressing ball 16a which is greater in diameter than a central major part of the operating rod 16. The inner diameter of the first spring retainer 29 (i.e., the flange 29b) is set greater than the outer diameter of the pressing ball 16a.

The hydraulic booster 10 is, as illustrated in FIG. 11, equipped with a stationary member 90 of a hollow cylindrical shape and a centering member 91 working as a second elastic member. The stationary member 90 is, as can be seen from FIG. 9, disposed between the rear end of the first spring retainer 29 and the front end of the pedal return spring 27. The stationary member 90 is used as an outer peripheral member disposed around the outer periphery of the operating rod 16. The centering member 91 is installed between the outer periphery of the operating rod 16 and the stationary member 90 (i.e., the outer periphery member). The centering member 91 (i.e., the second elastic member) is of a hollow cylindrical shape and retained by the inner periphery of the stationary member 90. The stationary member 90 is made up of a first member 901, a second member 902, and a third member 903. Each of the first member 901, the second member 902, and the third member 903 is of an annular shape. The first member 901 is disposed between the rear end of the first spring retainer 29 and the pedal return spring 27. The second member 902 extends rearward from an inner peripheral end of the first member 902. The third member 903 extends from a rear end of the second member 902 inwardly in a radial direction of the stationary member 91. The first member 901 is urged frontward by the pedal return spring 27 to secure the stationary member 90 to the first spring retainer 29.

The centering member 91 is made of an elastic material such as rubber and, as described above, used as the second elastic member. The centering member 91 is made up of a body 911 and a wedge-shaped annular protrusion 912. The body 911 is made of a hollow cylinder and has a rectangular or square transverse section, as taken along the axial direction of the centering member 91. The body 911 may have curved or chamfered corners. The body 911 is fit in an annular groove defined by the rear end of the first spring retainer 29, the second member 902, and the third member 903 of the stationary member 90.

The protrusion 912 extends frontward from an inner peripheral edge of the body 911 in the form of a hollow cylindrical lip. The protrusion 912 also inclines, as indicated by a broken line in FIG. 11, slightly inwardly in the radial direction of the centering member 91. The centering member 91 is fit on the periphery of the operating rod 16 with an inner peripheral surface of the protrusion 912 being placed in contact with the operating rod 16. Before being installed on the operating rod 16, the protrusion 912, as described above, slants slightly inwardly. Therefore, after installed on the operating rod 16, the protrusion 912, as expressed by the broken line, elastically presses the whole of circumference of the operating rod 16 inwardly, thereby creating an elastic reactive force exerted on the first spring retainer 29 outwardly to center the first spring retainer 29 with respect to the longitudinal center line of the operating rod 16. This establishes and maintains coincidence between the center axes of the first spring retainer 29 and the operating rod 16.

The protrusion 912 of the centering member 92, as described already, extends from the base 911 toward the front of the operating rod 16, that is, in a direction in which the operating rod 16 advances in response to depression of the brake pedal 71 and also slants slightly inward in the radial direction of the operating rod 16, thus permitting smooth advancement of the operating rod 16. The direction in which the protrusion 912 extends from the base 911 is opposite that in which the operating rod 16 moves backward to the initial position thereof, and the tip of the protrusion 912 slants more inwardly than the base thereof, thus interfering with the backward movement of the operating rod 16 more greatly than the frontward movement thereof, that is, resulting in an increase in elastic pressure which is produced by the protrusion 912 and acts on the operating rod 16 when moving backward. In other words, the resistance, as created by the centering member 91, to the backward movement of the operating rod 16 is greater than that to the frontward movement thereof. This is useful when it is required to create a greater resistance to releasing of the brake pedal 71 than to depression of the brake pedal 71. The centering member 91 may alternatively be designed to have the protrusion 912 extending backward from the rear end thereof. This results in a greater resistance to the frontward movement of the operating rod 16 than to the rearward movement thereof.

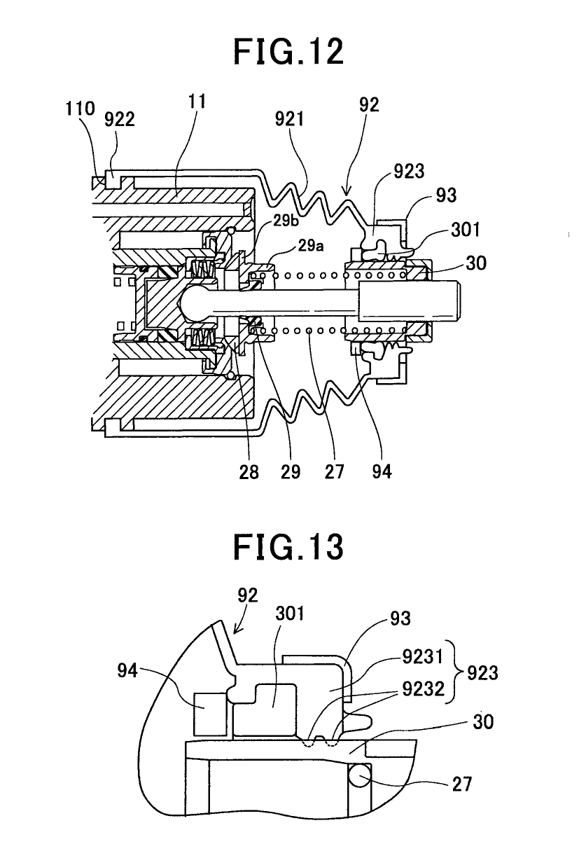

The hydraulic booster 10, as illustrated in FIGS. 12 and 13, also includes a boot 92 which covers the operating rod 16 and the rear opening of the master cylinder 11 fully. The boot 92 is made of an elastic material and consists of a bellows 921, a front stationary portion 922, and a rear stationary portion 923. The bellows 921 is made of a hollow cylinder with a corrugated wall and defines a central portion of the boot 92. The bellows 921 expands or contracts in the longitudinal direction of the boot 92 in response to the movement of the operating rod 16. The bellows 92 surrounds the operating rod 16 and the rear opening of the master cylinder 11 fully. The front stationary portion 922 extends inwardly from the front end of the bellows 921 in the radial direction of the boot 92 and serves as an annular fastener which is snap-fitted in an annular groove 110, as illustrated in FIGS. 9 and 12, formed in the outer periphery of the master cylinder 11.

The rear stationary portion 923 is of a hollow cylindrical shape and made of an elastic material. The rear stationary portion 923 extends from the rear end of the bellows 921 inwardly in the radial direction of the boot 92. The rear stationary portion 923, as clearly shown in FIG. 13, includes a body 9231 and a plurality of annular protrusions or ridges 9232. The body 9231, as can be seen in FIG. 13, has an annular groove formed in an inner circumference thereof. The ridges 9232 are placed in elastic contact with the outer periphery of the second spring retainer 30. A holder guide 301 is fit on the outer periphery of the second spring retainer 30. The holder guide 301 has an annular protrusion fit in the groove of the body 9231. The holder guide 301 is slidable on the outer periphery of the second spring retainer 30. A boot cover 93 is fit on the outer periphery of the body 9231 to press the body 9231 inwardly to secure it to the second spring retainer 30. The ridges 9232 extends on the whole of an inner circumference of a rear portion of the body 9231 and are of a substantially U-shape in transverse section. The ridges 9232 are pressed by the boot cover 93 through the body 9231 against the outer periphery of the second spring retainer 30 and are slightly elastically deformed.

Although not illustrated in detail, a second pedal return spring 94 is disposed between the first spring retainer 29 and the rear stationary portion 923. Specifically, the second pedal return spring 94 have a front end and a rear end. The rear end is, as can be seen in FIGS. 12 and 13, retained by the front ends of the body 9231 and the holder guide 301. The front end (not shown) of the second pedal return spring 94 is retained by the rear surface of the flange 29b of the first spring retainer 29.

When the operating rod 16 moves frontward, it will cause the second spring retainer 30 to move frontward in sliding contact with the ridges 9232 of the boot 92, thereby resulting in elastic deformation of the ridges 9232. Such elastic deformation creates resistance to the movement of the second spring retainer 30 to develop a hysteresis in the braking operation (i.e., the movement of the brake pedal 71).

The retaining piston 33 is, as clearly illustrated in FIG. 2, disposed inside the front portion of the second cylindrical portion 12c of the fail-safe cylinder 12 (i.e., within the cylindrical cavity 11p of the master cylinder 11) to be slidable in the longitudinal direction thereof. The retaining piston 33 is made of a bottomed cylindrical member and includes a front end defining a bottom 33a and a cylinder 33b extending rearward from the bottom 33a The bottom 33a has formed in the front end thereof a concave recess 33c serving as a retaining cavity. The bottom 33a has a C-ring groove 33e formed in an entire inner circumference of a front portion of the retaining cavity 33c. The bottom 33a also has a seal-retaining groove 33d formed on the outer circumference thereof. A seal 75 is fit in the seal-retaining groove 33d in contact with an entire inner circumference of the second cylindrical portion 12c of the fail-safe cylinder 12.

The movable member 32 is, as illustrated in FIG. 2, disposed inside the rear portion of the second cylindrical portion 12c of the fail-safe cylinder 12 (i.e., within the cylindrical cavity 11p of the master cylinder 11) to be slidable in the longitudinal direction thereof. The movable member 32 is made up of a flange 32a formed on the front end thereof and a shaft 32b extending backward from the flange 32a in the longitudinal direction of the hydraulic booster 10.

The flange 32a has a rubber-retaining chamber 32c formed in the front end thereof in the shape of a concave recess. In the rubber-retaining chamber 32c, the cylindrical simulator rubber 34 is fit which protrudes outside the front end of the rubber-retaining chamber 32c. When placed at an initial position, as illustrated in FIG. 2, the simulator rubber (i.e., the movable member 32) is located away from the retaining piston 33.

The flange 32a has formed therein a fluid path 32h which communicates between a cavity, as defined between the front end of the flange 32a and the inner wall of the retaining piston 33, and a major part of a simulator chamber 10f, which will be described later in detail. When the movable member 32 moves relative to the retaining piston 33, it will cause the brake fluid to flow from the cavity to the simulator chamber 10f or vice versa, thereby facilitating the sliding movement of the movable member 32 towards or away from the retaining piston 33.

The simulator chamber 10f is defined by the inner wall of the second cylindrical portion 12c of the fail-safe cylinder 12, the rear end of the retaining piston 33, and the front end of the input piston 15. The simulator chamber 10f is filled with the brake fluid. The simulator rubber 34 is, as described above, separate from the retaining piston 33, thereby allowing the simulator rubber 34 to experience a stroke L (will also be referred to as a loss stroke) within the simulator chamber 10f.

The simulator spring 26 is a braking simulator member engineered as a braking operation simulator and disposed between the flange 32a of the movable member 32 and the spring-retaining chamber 15b of the input piston 15 within the simulator chamber 10f. In other words, the simulator spring 26 is located ahead of the input piston 15 within the second cylindrical portion 12c of the fail-safe cylinder 12 (i.e., the cylindrical cavity 11p of the master cylinder 11). The shaft 32b of the movable member 32 is inserted into the simulator spring 26 to retain the simulator spring 26. The simulator spring 26 has a front portion press-fit on the shaft 32b of the movable member 32. With these arrangements, when the input piston 15 advances further from where the simulator rubber 34 (i.e., the movable member 32) hits the retaining piston 33, it will cause the simulator spring 26 to urge the input piston 15 backward.

The first inner ports 12d open at the outer periphery of the first cylindrical portion 12b of the fail-safe cylinder 12. The second cylindrical portion 12c is, as described above, shaped to have the outer diameter c greater than the outer diameter b of the first cylindrical portion 12b. Accordingly, the exertion of the accumulator pressure on the fifth port 11f (i.e., when the brake fluid is being supplied from the accumulator 61 to the fifth port 11f) will cause force or hydraulic pressure, as created by the accumulator pressure (i.e., the pressure of the brake fluid delivered from the accumulator 61) and a difference in traverse cross-section between the first cylindrical portion 12b and the second cylindrical portion 12c, to press the fail-safe cylinder 12 rearward against the stopper 21, thereby placing the fail-safe cylinder 12 at a rearmost position (i.e., the initial position) of the above describe preselected allowable range.

When the fail-safe cylinder 12 is in the initial position, the fourth inner ports 12g communicate with the seventh port 11h of the master cylinder 11. Specifically, the hydraulic communication between the simulator chamber 10f and the reservoir 19 is established by a reservoir flow path, as defined by the fourth inner ports 12g and the seventh port 11h. The simulator chamber 10f is a portion of the cylindrical cavity 11p, as defined ahead the input piston 15 inside the fail-safe cylinder 12. A change in volume of the simulator chamber 10f arising from the longitudinal sliding movement of the input piston 15 causes the brake fluid within the simulator chamber 10f to be returned back to the reservoir 19 or the brake fluid to be supplied from the reservoir 19 to the simulator chamber 10f, thereby allowing the input piston 15 to move frontward or backward in the longitudinal direction thereof without undergoing any hydraulic resistance.

The spool cylinder 24 is, as illustrated in FIGS. 2 and 4, fixed in the first cylindrical portion 12b of the fail-safe cylinder 12 (i.e., the cylindrical cavity 11p of the master cylinder 11) behind the second master piston 14. The spool cylinder 24 is of a substantially hollow cylindrical shape. The spool cylinder 24 has seal-retaining grooves 24a and 24b formed in an outer periphery thereof in the shape of a concave recess. Sealing members 57 and 58 are fit in the seal-retaining grooves 24a and 24b in direct contact with an entire circumference of the inner wall of the first cylindrical portion 12b to create a hermetical seal therebetween. The sealing members 57 and 58 develop mechanical friction between themselves and the inner wall of the first cylindrical portion 12b to hold the spool cylinder 24 from advancing in the first cylindrical portion 12b. The spool cylinder 24 has the rear end placed in contact with the stopper 12m, so that it is held from moving backward.

The spool cylinder 24 has formed therein a spool port 24c which communicates between inside and outside thereof. The spool port 24c communicates with the first inner ports 12d. The spool cylinder 24 has a first spool groove 24d formed in a portion of an inner wall thereof which is located behind the spool port 24c. The first spool groove 24d extends along an entire inner circumference of the spool cylinder 24 in the shape of a concave recess. The spool cylinder 24 also has a second spool groove 24f formed in a rear end of the inner wall thereof which is located behind the first spool groove 24d. The second spool groove 24f extends along the entire inner circumference of the spool cylinder 24 in the shape of a concave recess.

The spool cylinder 24 also has a fluid flow groove 24e formed in a portion of an outer wall thereof which is located behind the seal-retaining groove 24b. The fluid flow groove 24e extends along an entire outer circumference of the spool cylinder 24 in the shape of a concave recess. The third inner port 12f opens into the fluid flow groove 24e. Specifically, the fluid flow groove 24e defines a flow path leading to the reservoir 19 through the third inner port 12f and the sixth port 11g.

The spool piston 23 is made of a cylindrical shaft which is of a circular cross section. The spool piston 23 is disposed inside the spool cylinder 24 to be slidable in the longitudinal direction thereof. The spool piston 23 has a conical rear end defining a fixing portion 23a which is greater in outer diameter than another part thereof. The fixing portion 23a is disposed inside the retaining cavity 33c of the retaining piston 33. The C-ring 85 is fit in the C-ring groove 33e of the retaining piston 33 to stop the spool piston 23 from being removed forward from the retaining cavity 33c of the retaining piston 33, so that the spool piston 23 is held by the retaining piston 33 to be slidable in the longitudinal direction thereof. The spool piston 23 may alternatively be designed to have a portion which is formed other than the rear end and which engages the retaining cavity 33c instead of the fixing portion 23a.

The damper 37 is installed between the bottom of the retaining groove 33c and the rear end of the spool piston 23. The damper 37 is made of a cylindrical elastic rubber, but may alternatively be implemented by an elastically deformable member such as a coil spring or a diaphragm.

The spool piston 23 has a third spool groove 23b formed in an axial central portion of an outer wall thereof. The third spool groove 23b extends along an entire outer circumference of the spool piston 23 in the shape of a concave recess. The spool piston 23 also has a fourth spool groove 23c formed in a portion of the outer wall thereof which is located behind the third spool groove 23b. The fourth spool groove 23c extends along the entire outer circumference of the spool piston 23 in the shape of a concave recess. The spool piston 23 also has an elongated fluid flow hole 23e which extends along the longitudinal center line thereof from the front end behind the middle of the length of the spool piston 23. The spool piston 23 also has formed therein a first fluid flow port 23d and a second fluid flow port 23f which communicate between the fourth spool groove 23c and the fluid flow hole 23e.

Referring back to FIG. 2, the hydraulic booster 10 also includes a servo chamber 10c which is defined by the rear inner wall of the second master piston 14, the front end portion of the spool piston 23, and the front end of the spool cylinder 24 behind the retaining portion 14c of the second master piston 14 within the cylindrical cavity 11p of the master cylinder 11.

The first spool spring retainer 38 is, as clearly illustrated in FIG. 2, made up of a retaining disc 38a and a cylindrical fastener 38b. The retaining disc 38a is fit in an inner front end wall of the front cylindrical portion 12a of the fail-safe cylinder 12 and closes a front opening of the front cylindrical portion 12a. The cylindrical fastener 38b extends frontward from the front center of the retaining disc 38a. The cylindrical fastener 38b has an internal thread formed in an inner periphery thereof. The retaining disc 38a has a contact portion 38c formed on a central area of the rear end thereof. The retaining disc 38a also has fluid flow holes 38d passing through the thickness thereof.

The pushing member 40 is made of a rod and has a rear end engaging the internal thread of the cylindrical fastener 38b.

The second spool spring retainer 39 is, as illustrated in FIG. 4, made up of a hollow cylindrical body 39a and a ring-shaped retaining flange 39b The cylindrical body 39a has a front end defining a bottom 39c. The retaining flange 39b extends radially from the rear end of the cylindrical body 39a. The front end of the spool piston 23 is fit in the cylindrical body 39a in engagement with an inner periphery of the cylindrical body 39a, so that the second spool spring retainer 39 is secured to the front end of the spool piston 23. The bottom 39c has a through hole 39d formed therein. The second spool spring retainer 39 is, as can be seen from FIG. 2, aligned with the first spool spring retainer 38 at a given interval away from the contact portion 38c.

The spool spring 25 is, as illustrated in FIGS. 2 and 4, disposed between the retaining disc 38a of the first spool spring retainer 38 and the retaining flange 39b of the second spool spring retainer 39. The spool spring 25 works to urge the spool piston 23 backward relative to the fail-safe cylinder 12 (i.e., the master cylinder 11) and the spool cylinder 24.

The spring constant of the simulator spring 26 is set greater than that of the spool spring 25. The spring constant of the simulator spring 26 is also set greater than that of the pedal return spring 27.

### Simulator

The simulator made up of the simulator spring 26, the pedal return spring 27, and the simulator rubber 34 will be described below. The simulator is a brake simulating mechanism engineered to apply a reaction force to the brake pedal 71 to imitate an operation of a typical brake system, that is, make the driver of the vehicle experience the sense of depression of the brake pedal 71.

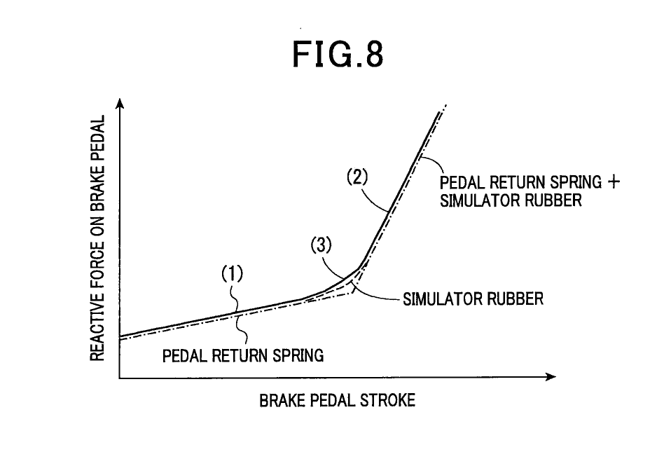

When the brake pedal 71 is depressed, the pedal return spring 27 contracts, thereby creating a reaction pressure (which will also be referred to as a reactive force) acting on the brake pedal 71. The reaction pressure is given by, as represented by a segment (1) in the graph of FIG. 8, the sum of a set load of the pedal return spring 27 and a product of the spring constant of the pedal return spring 27 and the stroke of the brake pedal 71 (i.e., the connecting member 31).

When the brake pedal 71 is further depressed, and the simulator rubber 34 hits the retaining piston 33, the pedal return spring 27 and the simulator spring 26 contract. The reaction pressure acting on the brake pedal is given by, as represented by a segment (2) in the graph of FIG. 8, a combination of physical loads generated by the simulator spring 26 and the pedal return spring 27. Specifically, a rate of increase in reaction pressure exerted on the brake pedal 71 during the stroke of the brake pedal 71 (i.e., unit of depression of the brake pedal 71) after the simulator rubber 34 contacts the retaining piston 33 will be greater than that before the simulator rubber 34 contacts the retaining piston 33.

When the simulator rubber 34 contacts the retaining piston 33, and the brake pedal 71 is further depressed, it usually causes the simulator rubber 34 to be contracted. The simulator rubber 34 has the spring constant which increases, in the nature thereof, as the simulator rubber 34 contracts. Therefore, there is, as indicated by a segment (3) in FIG. 8, a transient time for which the reaction pressure exerted on the brake pedal 71 changes gently to minimize the driver's discomfort arising from a sudden change in reaction pressure exerted on the foot of the driver of the vehicle.

Specifically, the simulator rubber 34 serves as a cushion to decrease the rate of change in reaction pressure acting on the brake pedal 71 during the depression thereof. The simulator rubber 34 of this embodiment is, as described above, secured to the movable member 32, but may be merely placed between opposed end surfaces of the movable member 32 and the retaining piston 33. The simulator rubber 34 may alternatively be attached to the rear end of the retaining piston 33.

As described above, the reaction pressure exerted on the brake pedal 71 during the depression thereof increases at a smaller rate until the simulator rubber 34 contacts the retaining piston ((1) in FIG. 8) and then increases at a greater rate ((2) in FIG. 8), thereby giving a typical sense of operation (i.e., depression) of the brake pedal 71 to the driver of the vehicle.

### Pressure Regulator

The pressure regulator 53 works to increase or decrease the master pressure that is the pressure of brake fluid delivered from the master chambers 10a and 10b to produce wheel cylinder pressure to be fed to the wheel cylinders WCfl, WCfr, WCrl, and WCrr and is engineered to achieve known anti-lock braking control or known electronic stability control to avoid lateral skid of the vehicle. The wheel cylinders WCfr and WCfl are connected to the first port 11b of the first master cylinder 10a through the pipe 52 and the pressure regulator 53. Similarly, the wheel cylinders WCrr and WCrl are connected to the third port 11d of the second master cylinder 10b through the pipe 51 and the pressure regulator 53.

Component parts of the pressure regulator 53 used to deliver the wheel cylinder pressure to, as an example, the wheel cylinder WCfr will be described below. The pressure regulator 53 also has the same component parts for the other wheel cylinders WCfl, WCrl, and WCrr, and explanation thereof in detail will be omitted here for the brevity of disclosure. The pressure regulator 53 is equipped with a pressure-holding valve 531, a pressure-reducing valve 532, a pressure control reservoir 533, a pump 534, an electric motor 535, and a hydraulic pressure control valve 536. The pressure-holding valve 531 is implemented by a normally-open electromagnetic valve (also called a solenoid valve) and controlled in operation by the brake ECU 6. The pressure-holding valve 531 is connected at one of ends thereof to the hydraulic pressure control valve 536 and at the other end to the wheel cylinder WCfr and the pressure-reducing valve 532.

The pressure-reducing valve 532 is implemented by a normally closed electromagnetic valve and controlled in operation by the brake ECU 6. The pressure-reducing valve 532 is connected at one of ends thereof to the wheel cylinder WCfr and the pressure-holding valve 531 and at the other end to a reservoir chamber 533e of the pressure control reservoir 533 through a first fluid flow path 157. When the pressure-reducing valve 532 is opened, it results in communication between the wheel cylinder WCfr and the reservoir chamber 533e of the pressure control reservoir 533, so that the pressure in the wheel cylinder WCfr drops.

The hydraulic pressure control valve 536 is implemented by a normally-open electromagnetic valve and controlled in operation by the brake ECU 6. The hydraulic pressure control valve 536 is connected at one of ends thereof to the first master chamber 10a and at the other end to the pressure-holding valve 531. When energized, the hydraulic pressure control valve 536 enters a differential pressure control mode to permit the brake fluid to flow from the wheel cylinder WCfr to the first master chamber 10a only when the wheel cylinder pressure rises above the master pressure by a given level.

The pressure control reservoir 533 is made up of a cylinder 533a, a piston 533b, a spring 533c, and a flow path regulator (i.e., flow control valve) 533d. The piston 544b is disposed in the cylinder 533a to be slidable. The reservoir chamber 533e is defined by the piston 533b within the cylinder 533a. The sliding of the piston 533b will result in a change in volume of the reservoir chamber 533e. The reservoir chamber 533e is filled with the brake fluid. The spring 533c is disposed between the bottom of the cylinder 533a and the piston 533b and urges the piston 533b in a direction in which the volume of the reservoir chamber 533e decreases.

The pipe 52 also leads to the reservoir chamber 533e through a second fluid flow path 158 and the flow regulator 533d. The second fluid flow path 158 extends from a portion of the pipe 52 between the hydraulic pressure control valve 536 and the first master chamber 10a to the flow regulator 533d. When the pressure in the reservoir chamber 533e rises, in other words, the piston 533b moves to increase the volume of the reservoir chamber 533e, the flow regulator 533d works to constrict a flow path extending between the reservoir chamber 533e and the second fluid flow path 158.

The pump 534 is driven by torque outputted by the motor 535 in response to an instruction from the brake ECU 6. The pump 534 has an inlet port connected to the reservoir chamber 533e through a third fluid flow path 159 and an outlet port connected to a portion of the pipe 52 between the hydraulic pressure control valve 536 and the pressure-holding valve 531 through a check valve z. The check valve z works to allow the brake fluid to flow only from the pump 534 to the pipe 52 (i.e., the first master chamber 10a). The pressure regulator 53 may also include a damper (not shown) disposed upstream of the pump 534 to absorb pulsation of the brake fluid outputted from the pump 534.

When the master pressure is not developed in the first master chamber 10a, the pressure in the reservoir chamber 533e leading to the first master chamber 10a through the second fluid flow path 158 is not high, so that the flow regulator 533d does not constrict the connection between the second fluid flow path 158 and the reservoir chamber 533e, in other words, maintains the fluid communication between the second fluid flow path and the reservoir chamber 533e. This permits the pump 534 to suck the brake fluid from the first master chamber 10a through the second fluid flow path 158 and the reservoir chamber 533e.

When the master pressure rises in the first master chamber 10a, it acts on the piston 533b through the second fluid flow path 158, thereby actuating the flow regulator 533d. The flow regulator 533d then constricts or closes the connection between the reservoir chamber 533e and the second fluid flow path 158.

When actuated in the above condition, the pump 534 discharges the brake fluid from the reservoir chamber 533e. When the amount of the brake fluid sucked from the reservoir chamber 533e to the pump 534 exceeds a given value, the flow path between the reservoir chamber 533e and the second fluid flow path 158 is slightly opened in the flow regulator 533d, so that the brake fluid is delivered from the first master chamber 10a to the reservoir chamber 533e through the second fluid flow path 158 and then to the pump 534.

When the pressure regulator 53 enters a pressure-reducing mode, and the pressure-reducing valve 532 is opened, the pressure in the wheel cylinder WCfr (i.e., the wheel cylinder pressure) drops. The hydraulic pressure control valve 536 is then opened. The pump 534 sucks the brake fluid from the wheel cylinder WCfr or the reservoir chamber 533e and returns it to the first master cylinder 10a.

When the pressure regulator 53 enters a pressure-increasing mode, the pressure-holding valve 531 is opened. The hydraulic pressure control valve 536 is then placed in the differential pressure control mode. The pump 534 delivers the brake fluid from the first master chamber 10a and the reservoir chamber 533e to the wheel cylinder WCfr to develop the wheel cylinder pressure therein.

When the pressure regulator 53 enters a pressure-holding mode, the pressure-holding valve 531 is closed or the hydraulic pressure control valve 536 is placed in the differential pressure control mode to keep the wheel cylinder pressure in the wheel cylinder WCfr as it is.

As apparent from the above discussion, the pressure regulator 53 is capable of regulating the wheel cylinder pressure regardless of the operation of the brake pedal 71. The brake ECU 6 analyzes the master pressure, speeds of the wheels Wfr, Wfl, Wrr, and Wrl, and the longitudinal acceleration acting on the vehicle to perform the anti-lock braking control or the electronic stability control by controlling on-off operations of the pressure-holding valve 531 and the pressure-reducing valve 532 and actuating the motor 534 as needed to regulate the wheel cylinder pressure to be delivered to the wheel cylinder WCfr.

### Operation of Hydraulic Booster

The operation of the hydraulic booster 10 will be described below in detail. The hydraulic booster 10 is equipped with a spool valve that is an assembly of the spool cylinder 24 and the spool piston 23. Upon depression of the brake pedal 71, the spool valve is moved as a function of the driver's effort on the brake pedal 71. The hydraulic booster 10 then enters any one of the pressure-reducing mode, the pressure-increasing mode, and the pressure-holding mode.

### Pressure-Reducing Mode

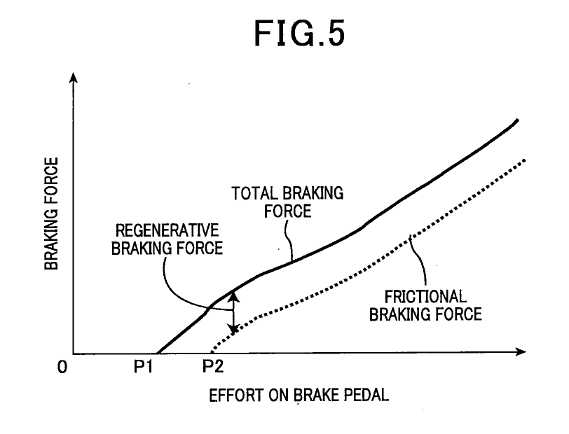

The pressure-reducing mode is entered when the brake pedal 71 is not depressed or the driver's effort (which will also be referred to as braking effort below) on the brake pedal 71 is lower than or equal to a frictional braking force generating level P2, as indicated in a graph of FIG. 5. When the brake pedal is, as illustrated in FIG. 2, released, so that the pressure-reducing mode is entered, the simulator rubber 34 (i.e., the movable member 32) is separate from the bottom 33a of the retaining piston 33.

When the simulator rubber 34 is located away from the bottom 33a of the retaining piston 33, the spool piston 23 is placed by the spool spring 25 at the rearmost position in the movable range thereof (which will also be referred to as a pressure-reducing position below). The spool port 24c is, as illustrated in FIG. 4, blocked by the outer periphery of the spool piston 23, so that the accumulator pressure that is the pressure in the accumulator 61 is not exerted on the servo chamber 10c.

The fourth spool groove 23c of the spool piston 23, as illustrated in FIG. 4, communicates with the second spool groove 24f of the spool cylinder 24. The servo chamber 10c, therefore, communicates with the reservoir 19 through a pressure-reducing flow path, as defined by the fluid flow hole 23e, the first fluid flow part 23d, the fourth spool groove 23c, the second spool groove 24f, the fluid flow path 12n, the fluid flow groove 24e, the third inner port 12f, and the sixth port 11g. This causes the pressure in the servo chamber 10c to be equal to the atmospheric pressure, so that the master pressure is not developed in the first master chamber 10a and the second master chamber 10b.

When the brake pedal 71 is depressed, and the simulator rubber 34 touches the bottom 33a of the retaining piston 33 to develop the pressure (which will also be referred to as an input pressure below) urging the spool piston 23 forward through the retaining piston 33, but such pressure is lower in level than the pressure, as produced by the spool spring 25 and exerted on the spool piston 23, the spool piston 23 is kept from moving forward in the pressure-reducing position. Note that the above described input pressure exerted on the spool piston 23 through the retaining piston 33 is given by subtracting a load required to compress the pedal return spring 27 from a load applied to the connecting member 31 upon depression of the brake pedal 71. When the load or effort applied to the brake pedal 71 is lower than or equal to the frictional braking force generating level P2, the hydraulic booster 10 is kept from entering the pressure-increasing mode, so that the servo pressure and the master pressure are not developed, thus resulting in no frictional braking force generated in the friction braking devices Bfl, Bfr, Brl, and Brr.

### Pressure-Increasing Mode

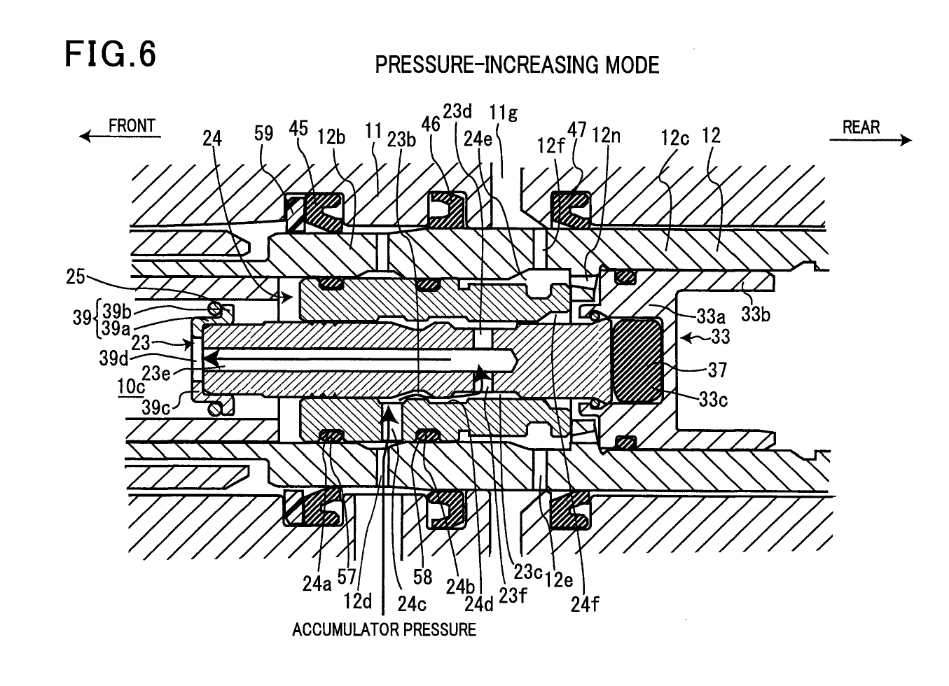

When the effort on the brake pedal 71 exceeds the frictional braking force generating level P2, the hydraulic booster 10 enters the pressure-increasing mode. Specifically, the application of effort to the brake pedal 71 causes the simulator rubber 34 (i.e., the movable member 32) to push the retaining piston 33 to urge the spool piston 23 forward. The spool piston 23 then advances to a front position, as illustrated in FIG. 6 within the movable range against the pressure, as produced by the spool spring 25. Such a front position will also be referred to as a pressure-increasing position below.

When the spool piston 23 is in the pressure-increasing position, as illustrated in FIG. 6, the first fluid flow port 23d is closed by the inner periphery of the spool cylinder 24 to block the communication between the first fluid flow part 23d and the second spool groove 24f. This blocks the fluid communication between the servo chamber 10c and the reservoir 19.

Further, the spool port 24c communicates with the third spool groove 23b. The third spool groove 23b, the first spool groove 24d, and the fourth spool groove 23c communicate with each other, so that the pressure in the accumulator 61 (i.e., the accumulator pressure) is delivered to the servo chamber 10c through a pressure-increasing flow path, as defined by the first inner port 12d, the spool port 24c, the third spool groove 23b, the first spool groove 24d, the fourth spool groove 23c, the second fluid flow port 23f, the fluid flow hole 23e, and the connecting hole 39d. This results in a rise in servo pressure.

The rise in servo pressure will cause the second master piston 14 to move forward, thereby moving the first master piston 13 forward through the second return spring 18. This results in generation of the master pressure within the second master chamber 10b and the first master chamber 10a. The master pressure increases with the rise in servo pressure. In this embodiment, the diameter of the front and rear seals (i.e., the sealing members 43 and 44) of the second master piston 14 is identical with that of the front and rear seals (i.e., the sealing members 41 and 42) of the first master piston 13, so that the servo pressure will be equal to the master pressure, as created in the second master chamber 10b and the first master chamber 10a.

The generation of the master pressure in the second master chamber 10b and the first master chamber 10a will cause the brake fluid to be delivered from the second master chamber 10b and the first master chamber 10a to the wheel cylinders WCfr, WCfl, WCrr, and WCrl through the pipes 51 and 52 and the pressure regulator 53, thereby elevating the pressure in the wheel cylinders WCfr, WCfl, WCrr, and WCrl (i.e., the wheel cylinder pressure) to produce the frictional braking force applied to the wheels Wfr, Wfl, Wrr, and Wrl.

### Pressure-Holding Mode

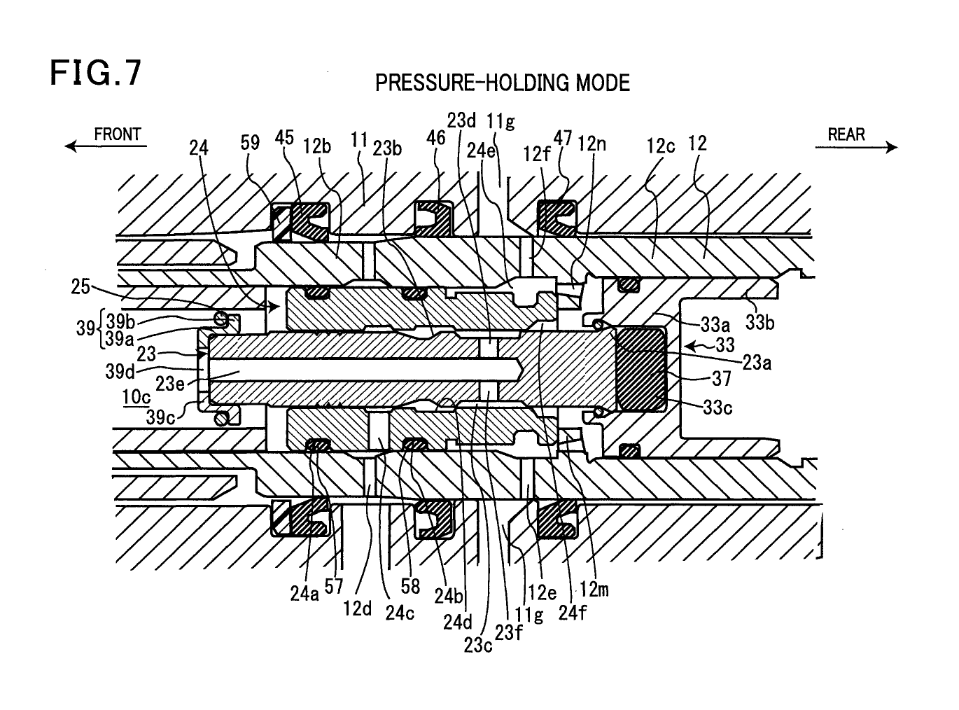

When the spool piston 23 is in the pressure-increasing position, the accumulator pressure is applied to the servo chamber 10c, so that the servo pressure rises. This causes a return pressure that is given by the product of the servo pressure and a cross-sectional area of the spool piston 23 (i.e., a seal area) to act on the pool piston 23 backward. When the sum of the return pressure and the pressure, as produced by the spool spring 25 and exerted on the spool piston 23, exceeds the input pressure exerted on the spool piston 23, the spool piston 23 is moved backward and placed in a pressure-holding position, as illustrated in FIG. 7, that is intermediate between the pressure-reducing position and the pressure-increasing position.

When the spool piston 23 is in the pressure-holding position, as illustrated in FIG. 7, the spool port 24c is closed by the outer periphery of the spool piston 23. The fourth spool groove 23c is also closed by the inner periphery of the spool cylinder 24. This blocks the communication between the spool port 24c and the second fluid flow port 23f to block the communication between the servo chamber 10c and the accumulator 61, so that the accumulator pressure is not applied to the servo chamber 10c.

Further, the fourth spool groove 23c is closed by the inner periphery of the spool cylinder 24, thereby blocking the communication between the first fluid flow port 23d and the second spool groove 24f to block the communication between the servo chamber 10c and the reservoir 19, so that the servo chamber 10c is closed completely. This causes the servo pressure, as developed upon a change from the pressure-increasing mode to the pressure-holding mode, to be kept as it is.

When the sum of the return pressure exerted on the spool piston 23 and the pressure, as produced by the spool spring 25 and exerted on the spool piston 23, is balanced with the input pressure exerted on the spool piston 23, the pressure-holding mode is maintained. When the effort on the brake pedal 71 drops, so that the input pressure applied to the spool piston 23 decreases, and the sum of the return pressure applied to the spool piston 23 and the pressure, as produced by the spool spring 25 and exerted on the spool piston 23, exceeds the input pressure exerted on the spool piston 23, it will cause the spool piston 23 to be moved backward and placed in the pressure-reducing position, as illustrated in FIG. 4. The pressure-reducing mode is then entered, so that the servo pressure in the servo chamber 10c drops.

Alternatively, when the spool piston 23 is in the pressure-holding position, and the input pressure applied to the spool piston 23 rises with an increase in braking effort on the brake pedal 71, so that the input pressure acting on the spool piston 23 exceeds the sum of the return pressure exerted on the spool piston 23 and the pressure, as produced by the spool spring 25 and exerted on the spool piston 23, it will cause the spool piston 23 to be moved forward, and placed in the pressure-increasing position, as illustrated in FIG. 6. The pressure-increasing mode is then entered, so that the servo pressure in the servo chamber 10c rises.

Usually, the friction between the outer periphery of the spool piston 23 and the inner periphery of the spool cylinder 24 results in hysteresis in the movement of the spool piston 23, which disturbs the movement of the spool piston 23 in the longitudinal direction thereof, thus leading to less frequent switching from the pressure-holding mode to either of the pressure-reducing mode or the pressure-increasing mode.

### Relation Between Regenerative Braking Force and Frictional Braking Force

The relation between the regenerative braking force and the frictional braking force will be described below with reference to FIG. 5. When the braking effort on the brake pedal 71 is lower than or equal to the frictional braking force generating level P2, the hydraulic booster 10 is kept in the pressure-reducing mode without being switched to the pressure-increasing mode, so that the frictional braking force is not created. The brake system B has a regenerative braking force generating level P1 indicative of the braking effort applied to the brake pedal 71 which is set lower than the frictional braking force generating level P2.

The brake system B is equipped with the brake sensor 72. The brake sensor 72 is a pedal position sensor which measures an amount of stroke of the brake pedal 71. The driver's effort (i.e. the braking effort) applied to the brake pedal 71, as can be seen in the graph of FIG. 8, has a given correlation with the amount of stroke of the brake pedal 71. The brake ECU 6, thus, determines whether the braking effort has exceeded the regenerative braking force generating level P1 or not using the output from the brake sensor 72.

When the brake pedal 71 has been depressed, and the brake ECU 6 determines that the braking effort on the brake pedal 71 has exceeded the regenerative braking force generating level P1, as indicated in FIG. 5, the brake ECU 6, as described above, calculates the target regenerative braking force as a function of the output from the brake sensor 72 and outputs a signal indicative thereof to the hybrid ECU 900.

The hybrid ECU 900 uses the speed V of the vehicle, the state of charge in the battery 507, and the target regenerative braking force to compute the actually producible regenerative braking force that is a regenerative braking force the regenerative braking system A is capable of producing actually. The hybrid ECU 900 then controls the operation of the regenerative braking system A to create the actually producible regenerative braking force.

When determining that the actually producible regenerative braking force does not reach the target regenerative braking force, the hybrid ECU 900 subtracts the actually producible regenerative force from the target regenerative braking force to derive an additional frictional braking force. The event that the actually producible regenerative braking force does not reach the target regenerative braking force is usually encountered when the speed V of the vehicle is lower than a given value or the battery 507 is charged fully or near fully. The hybrid ECU 900 outputs a signal indicative of the additional frictional braking force to the brake ECU 6.

Upon reception of the signal from the hybrid ECU 900, the brake ECU 6 controls the operation of the pressure regulator 53 to control the wheel cylinder pressure to make the friction braking devices Bfl, Bfr, Brl, and Brr create the additional regenerative braking force additionally. Specifically, when it is determined that the actually producible regenerative braking force is less than the target regenerative braking force, the brake ECU 6 actuates the pressure regulator 53 to develop the additional regenerative braking force in the friction braking devices Bfl, Bfr, Brl, and Brr to compensate for a difference (i.e., shortfall) between the target regenerative braking force and the actually producible regenerative braking force, thereby achieving the target regenerative braking force.

As described above, when the hybrid ECU 900 has decided that it is impossible for the regenerative braking system A to produce a required regenerative braking force (i.e., the target regenerative braking force), the pressure regulator 53 regulates the pressure to be developed in the wheel cylinders WCfl, WCfr, WCrl, and WCrr to produce a degree of frictional braking force through the friction braking devices Bfl, Bfr, Brl, and Brr which is equivalent to a shortfall in the regenerative braking force.

### Operation of Hydraulic Booster in Event of Malfunction of Hydraulic Pressure Generator

When the hydraulic pressure generator 60 has failed in operation, so that the accumulator pressure has disappeared, the fail-safe spring 36 urges or moves the fail-safe cylinder 12 forward until the flange 12h of the fail-safe cylinder 12 hits the stopper ring 21c of the stopper 21. The second cylindrical portion 12c of the fail-safe cylinder 12 then blocks the seventh port 11h of the master cylinder 11 to close the simulator chamber 10f liquid-tightly.

When the simulator chamber 10f is hermetically closed, and the brake pedal 71 is depressed, it will cause the braking effort applied to the brake pedal 71 to be transmitted from the input piston 15 to the retaining piston 33 through the connecting member 31 and the operating rod 16, so that the retaining piston 33, the spool piston 23, and the second spool spring retainer 39 advance.

Upon hitting of the retaining piston 33 on the stopper 12m in the fail cylinder 12, the braking effort on the brake pedal 71 is transmitted to the fail-safe cylinder 12 through the stopper 12m, so that the fail-safe cylinder 12 advances. This causes the pushing member 40 to contact the retaining portion 14c of the second master piston 14 or the pressing surface 12i of the fail-safe cylinder 12 to contact the rear end of the second cylindrical portion 14b of the second master piston 14, so that the braking effort on the brake pedal 71 is inputted to the second master piston 14. In this way, the fail-safe cylinder 12 pushes the second master piston 14.

As apparent from the above discussion, in the event of malfunction of the hydraulic pressure generator 60, the braking effort applied to the brake pedal 71 is transmitted to the second master piston 14, thus developing the master pressure in the second master chamber 10b and the first master chamber 10a. This produces the frictional braking force in the friction braking devices Bfl, Bfr, Brl, and Brr to decelerate or stop the vehicle safely.

The depression of the brake pedal 71 in the event of malfunction of the hydraulic pressure generator 60, as described above, results in frontward movement of the fail-safe cylinder 12, thereby causing the first spring retainer 29 for the pedal return spring 27 to move forward. This causes the braking effort on the brake pedal 71 not to act on the pedal return spring 27. The braking effort is, therefore, not attenuated by the compression of the pedal return spring 27, thereby avoiding a drop in the master pressure arising from the attenuation of the braking effort.

In the event of malfunction of the hydraulic pressure generator 60, the fail-safe cylinder 12 advances, so that the second cylindrical portion 12c which has the outer diameter c greater than the outer diameter b of the first cylindrical portion 12b passes through the sealing member 45. The master cylinder 11 is designed to have the inner diameter greater than the outer diameter c of the second cylindrical portion 12c for allowing the second cylindrical portion 12c to move forward. Consequently, when the hydraulic pressure generator 60 is operating properly, the outer periphery of the first cylindrical portion 12b is, as can be seen in FIG. 2, separate from the inner periphery of the master cylinder 11 through air gap.

The entire area of the front end of the sealing member 45 is, as clearly illustrated in FIG. 4, in direct contact with the support member 59. The inner peripheral surface of the support member 59 is in direct contact with the outer peripheral surface of the first cylindrical portion 12b of the fail-safe cylinder 12. In other words, the sealing member 45 is firmly held at the front end thereof by the support member 59 without any air gap therebetween, thus avoiding damage to the sealing member 45 when the fail-safe cylinder 12 moves forward in the event of malfunction of the hydraulic pressure generator 60, so that the first cylindrical portion 12b slides on the sealing member 45.

The support member 59, as illustrated in FIG. 3, has a slit 59a formed therein. The slit 59a makes the support member 59 expand outwardly upon the forward movement of the fail-safe cylinder 12, thereby allowing the second cylindrical portion 12c to pass through the support member 59. The sealing member 45 is, as described above, held at the front end thereof by the support member 59, thus avoiding damage to the sealing member 45 upon the passing of the second cylindrical portion 12c through the support member 59.

If the accumulator pressure has risen excessively, so that the pressure in the fifth port 11f has exceeded a specified level, the mechanical relief valve 22 will be opened, so that the brake fluid flows from the fifth port 11f to the sixth port 11g and to the reservoir 19. This avoids damage to the pipe 67 and the hydraulic booster 10.

The brake system B of this embodiment offers the following advantages.

A structural combination of the sealing member 56 and the input piston 15 functions to develop a variable mechanical resistance to movement of members, such as the operating rod 16, etc., which are moved in response to depression or release of the brake pedal 71. The resistance has a value which is different between frontward movement and rearward movement of the members, thereby developing a great hysteresis of the brake operating effort (i.e., the pressure developed by depression of the brake pedal 71 and transmitted from the brake pedal 71 to the first input piston 151 (i.e., the simulator spring 26) through the second input piston 152 in response to the brake operating stroke (i.e., the amount of stroke of the input piston 15, in other words, the amount of stroke of the operating rod 16 or the brake pedal 71). Additionally, the centering member 91 and the rear stationary member 923 of the boot 92, like the sealing member 56, create the hysteresis in the relation of the brake operating effort to the brake operating stroke. Accordingly, the degree of hysteresis in the relation of the brake operating effort to the brake operating stroke may be regulated by changing the number, structure, material, size, or combination of the above elastic members with a high degree of freedom.

The simulator spring 26, as described above, urges the input piston 15 backward to function as a brake simulator which applies a reaction force to the brake pedal 71 to imitate an operation of a typical brake system. The simulator spring 26 is disposed inside the cylindrical cavity 11p of the master cylinder 11 of the hydraulic booster 10. In other words, the master pistons 13 and 14, the spool valve (i.e., the spool cylinder 24 and the spool piston 23), the simulator spring 26, and the input piston 15 are arranged in alignment with each other (i.e., in series with each other) within the cylindrical cavity 11p of the master cylinder 11. This layout facilitates the ease with which the brake system B is mounted in the vehicle in the form of a frictional brake unit.

The simulator rubber 34 is disposed away from the retaining piston 33 which supports the spool piston 23. This layout keeps the braking effort applied to the brake pedal 71 from being transmitted to the spool piston 23 until the simulator rubber 34 retained by the movable member 32 contacts the retaining piston 33. In other words, the frictional braking force is not created immediately after the depression of the brake pedal 71. After the braking effort exceeds the regenerative braking force generating level P1, as shown in the graph of FIG. 5, the regenerative braking system A starts developing the regenerative braking force. This minimizes the dissipation of thermal energy, into which kinetic energy of the vehicle is converted, from the friction braking devices Bfl, Bfr, Brl, and Brr, thereby enhancing the efficiency in using the kinetic energy of the vehicle as the regenerative braking force through the regenerative braking system A.

The movable member 32 which is disposed between the retaining piston 33 and the input piston 15 serves as a stopper to restrict the frontward movement of the input piston 15 upon depression of the brake pedal 71, thereby avoiding damage to the simulator spring 26.

The brake system B is engineered so as to switch among the pressure-reducing mode, the pressure-increasing mode, and the pressure-holding mode according to the longitudinal location of the spool piston 23, as moved in response to the braking effort on the brake pedal 71, within the spool cylinder 24. In other words, the frictional braking force is variably developed by the spool valve that is a mechanism made up of the spool piston 23 and the spool cylinder 24. This enables the frictional braking force to be changed more linearly than the case where the frictional braking force is regulated using a solenoid valve.

Specifically, in the case of use of the solenoid valve, a flow of brake fluid usually develops a physical force to lift a valve away from a valve seat when the solenoid valve is opened. This may lead to an excessive flow of the brake fluid from the solenoid valve, thus resulting in an error in regulating the pressure of the brake fluid and instability in changing the frictional braking force. In order to alleviate such a drawback, the brake system B is designed to have the spool piston 23 on which the driver's effort on the brake pedal 71 is exerted and switch among the pressure-reducing mode, the pressure-increasing mode, and the pressure-holding mode as a function of a change in the driver's effort, thereby developing the frictional braking force according to the driver's intention.

The damper 37 is, as illustrated in FIG. 4, installed between the retaining groove 33c of the retaining piston 33 and the rear end surface of the spool piston 23. The damper 37 is deformable or compressible to attenuate or absorb the impact which results from a sudden rise in pressure in the servo chamber 10c and is transmitted from the spool piston 23 to the retaining piston 33, thus reducing the impact reaching the brake pedal 71 to alleviate the discomfort of the driver.

The brake system B of the second embodiment will be described below which is different in structure of the sealing member 56 and the input piston 15 from the first embodiment. The same reference numbers as employed in the first embodiment will refer to the same parts, and explanation thereof in detail will be omitted here.

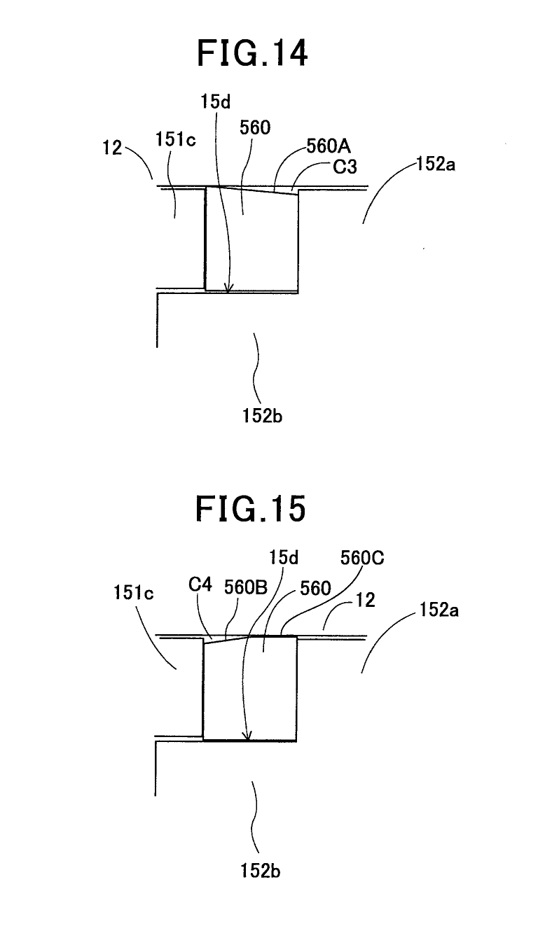

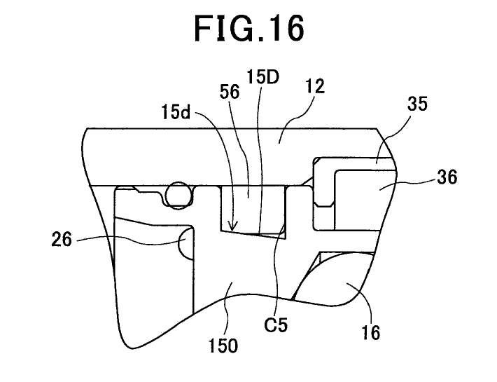

The hydraulic booster 10 of this embodiment, as illustrated in FIG. 14, includes a cylindrical sealing member 560 instead of the sealing member 56 of the first embodiment. The sealing member 560 is made of an annular elastic material and has a front end facing the front of the hydraulic booster 10 and a rear end facing the rear of the hydraulic booster 10. The sealing member 560 is of a substantially square transverse section, as taken in an axial direction thereof (i.e., the lengthwise direction of the hydraulic booster 10), and has an inner peripheral surface extending parallel to the axial direction thereof. The sealing member 560 also has an outer peripheral surface 560A which slants outwardly from the rear end thereof in a radial direction of the sealing member 560, in other words, slightly tapers toward the rear end thereof. The outer peripheral surface 560A will also be referred to as a slant surface below. The front end and the rear end of the sealing member 560 have surfaces, like in the first embodiment, extending perpendicular to the axial direction of the sealing member 560. The front end of the sealing member 560 has an outer edge (i.e., an outer corner) placed in direct contact with the inner peripheral surface of the fail-safe cylinder 12. The second input piston 152, like in the first embodiment, has the protrusion 152b whose outer peripheral surface extends parallel to the axial direction thereof (i.e., the axial direction of the sealing member 560).

When the brake pedal 71 is not depressed, a wedge-shaped air gap C3 exists between the outer peripheral surface 560A of the sealing member 560 other than the rear front thereof and the inner peripheral surface of the fail-safe cylinder 12. When the second input piston 152 of the input piston 15 advances, that is, moves toward the front of the hydraulic booster 10, it presses the sealing member 560 so that the size or volume of the air gap C3 decreases. This will result in an increase in area of contact of the slant surface 560A with the inner peripheral surface of the fail-safe cylinder 12, that is, an increase in pressure, as exerted by the sealing member 560 on the inner peripheral surface of the fail-safe cylinder 12, which leads to an increase in resistance to depression of the brake pedal 71.

The volume of the air gap C3 per unit thickness of the sealing member 560 in the axial direction thereof, as apparent from the above discussion, increases toward the rear end of the sealing member 560. This, like in the first embodiment, results in a difference in resistance to the movement of the second input piston 152 between when the second input piston 15 moves frontward and when it moves backward, thereby developing a great hysteresis of the brake operating effort in response to the brake operating stroke.

The sealing member 560 may alternatively be shaped as illustrated in FIG. 15. The sealing member 560 has a slant surface 560B which partially occupies the outer periphery thereof. Specifically, the slant surface 560B occupies a front half of the outer periphery of the sealing member 560. The sealing member 560 also has a flat surface 560C which occupies a rear half of the outer periphery of the sealing member 560 and extends substantially parallel to the axial direction of the sealing member 560. The flat surface 560C is placed in contact with the inner peripheral surface of the fail-safe cylinder 12. This geometry of the sealing member 560 creates an air gap C4 between the slant surface 560B of the sealing member 560 and the inner peripheral surface of the fail-safe cylinder 12, thereby developing a larger hysteresis of the brake operating effort in response to the brake operating stroke. The flat surface 560C serves to form an increased area of contact with the inner peripheral surface of the fail-safe cylinder 12 to enhance the degree of hermetic sealing between the sealing member 560 (i.e., the input piston 15) and the fail-safe cylinder 12.

The slant surface 560A may alternatively be shaped to incline inwardly from the rear of the sealing member 560. The slant surface 560B may alternatively be formed by a rear portion of the outer periphery of the sealing member 560 and incline inwardly toward the rear of the sealing member 560. The sealing member 560 may alternatively be designed to have the slant surface 560A or 560B formed on the inner periphery thereof.

The brake system B of the third embodiment will be described below which is different in structure of the sealing member 56 and the input piston 15 from the first embodiment. The same reference numbers as employed in the first embodiment will refer to the same parts, and explanation thereof in detail will be omitted here.

The hydraulic booster 10 of this embodiment has an input piston 150 formed by a one-piece member. In other words, the input piston 150 is not shaped to have the first input piston 151 and the second input piston 152. The input piston 150 has the seal retaining groove 15d formed in an outer periphery thereof. The seal retaining groove 15d has a slant bottom surface 15D which inclines outwardly from the rear end to the front end of the seal retaining groove 15d relative to the axial direction of the input piston 15. The sealing member 56 is made of an annular elastic material and has a rectangular or square transverse section, as taken in the axial direction of the sealing member 56. The sealing member 56 is fit in the seal retaining groove 15d with a front inner peripheral surface placed in abutment with the slant surface 15D of the seal retaining groove 15d. The front inner peripheral surface of the sealing member 56 is elastically pressed against the slant surface 15D, so that it is elastically deformed to have an area of hermetic contact with the slant surface 15D. This results in formation of an annular air gap C5 between the slant surface 15D of the seal retaining groove 15d and a rear inner peripheral surface of the sealing member 56.

When the brake pedal 71 is depressed, so that the input piston 150 advances, the input piston 150 slides on the inner periphery of the fail-safe cylinder 12, thus causing the sealing member 56 to be elastically deformed and bulge into the air gap C5. Specifically, when the input piston 150 moves frontward, the sealing member 56 is subjected to friction between itself and the inner peripheral surface of the fail-safe cylinder 12, so that it is elastically deformed into the air gap C5, thereby resulting in an increase in area of contact of the sealing member 56 with the slant surface 15D, that is, an increase in pressure, as exerted by the sealing member 56 on the fail-safe cylinder 12. This increases the resistance to the forward movement of the input piston 150 more than that to the rearward movement of the input piston 150. In other words, the resistance to the movement of the input piston 150 is, like in the above embodiments, increased gradually as the input piston 150 moves forward.

A combination of the sealing member 56 and the seal retaining groove 15d, therefore, creates a great hysteresis of the brake operating effort in response to the brake operating stroke. The input piston 15, as used in the above embodiments, which is made up of two discrete parts: the first input piston 151 and the second input piston 152 movable relative to each other is, however, capable of providing a greater degree of elastic deformation of the sealing member 56, which establishes the hysteresis which is greater than that in this embodiment.

The slant surface 15D of the seal retaining groove 15d may alternatively be shaped to slant outwardly from the front end to the rear end of the seal retaining groove 15d. This geometry of the seal retaining groove 15d, like in the above embodiment, creates the resistance to the backward movement of the input piston 150 which is smaller than that to the frontward movement of the input piston 150.

### Modifications

The braking device (i.e., the brake system B) of the above embodiment is equipped with the brake sensor 72 which measures the degree of effort applied to the brake pedal 71 in the form of the amount of stroke of the brake pedal 71, but the brake sensor 72 may be designed as a stroke sensor to measure the amount of stroke of the input piston 15, the connecting member 31 or the operating rod 16 as representing the degree of effort exerted on the brake pedal 71. The brake sensor 72 may alternatively be engineered as a load sensor to detect a degree of physical load acting on the brake pedal 71, the input piston 15, the connecting member 31, or the operating rod 16.

The hydraulic booster 10 may be designed to have an additional simulator spring disposed between the movable member 32 and the retaining piston 33. The additional simulator spring is preferably set smaller in spring constant than the simulator spring 26.

The brake system B (i.e., the hydraulic booster 10) is, as described above, mounted in the hybrid vehicle equipped with the regenerative braking system A, but may be installed in another type of vehicle with no regenerative braking system.

The brake system B uses the brake pedal 71 as a brake actuating member which inputs or transmits the driver's braking effort to the input piston 15, but may alternatively employ a brake lever or a brake handgrip instead of the brake pedal 71. The brake system B may also be used with motorbikes or another type of vehicles.

The brake system B, as described above, has the brake simulator (i.e., the simulator spring 26) and the pressure regulator 53 installed in the master cylinder 11, however, may be used with vehicles in which they are disposed outside the master cylinder 11. In other words, the brake system B may be installed in vehicles where the hydraulic booster 10, the brake simulator, and the pressure regulator 53 are separate from each other. Further, the fail-safe cylinder 12 may be omitted in the hydraulic booster 10. The above described embodiment uses the fail-safe cylinder 12 as the outer peripheral member which is disposed outside the outer periphery of the movable member (i.e., input piston 15), but however, the master cylinder 11 may be used as the outer peripheral member. The seal retaining groove 15d is made in the input piston 15, but may alternatively be formed in the outer peripheral member (i.e., the fail-safe cylinder 12 or the master cylinder 11).

The brake system B of the above embodiments is, as described above, designed as a vehicular braking device and may be constructed by a combination of the above described components: the master cylinder 11, the accumulator 61, the reservoir 19, a master piston (i.e., the first and second master piston 13 and 14), a spool valve (i.e., the spool piston 23 and the spool cylinder 24), a brake actuating member (i.e. the brake pedal 71), the input piston 15, and a braking simulator member (i.e., the simulator spring 26).

The master cylinder 11, as described above, has a given length with a front and a rear in the axial direction thereof. The master cylinder 11 has the cylindrical cavity 11p extending in the longitudinal direction of the master cylinder 11. The accumulator 61 connects with the cylindrical cavity 11p of the master cylinder 11 and stores the brake fluid under pressure. The reservoir 19 connects with the cylindrical cavity 11p of the master cylinder 11 and stores the brake fluid therein. The master piston is disposed in the cylindrical cavity 11p to be slidable in the longitudinal direction thereof. The master piston has a front oriented to the front of the master cylinder 11 and a rear oriented to the rear of the master cylinder 11. The master piston defines a master chamber (i.e., the first master chamber 10a and the second master chamber 10b) and the servo chamber 10c within the cylindrical cavity 11p. The master chamber is formed on the front side of the master piston and stores therein the brake fluid to be delivered to a brake device (the friction braking devices Bfl, Bfr, Brl, or Brr) working to apply a frictional braking force to a wheel (i.e., the wheel Wfl, Wfr, Wrl, or Wrr of the vehicle). The servo chamber 10c is formed on the rear side of the master piston. The spool valve is disposed on the rear side of the master piston within the cylindrical cavity 11p of the master cylinder 11. The spool valve works to switch among the pressure-reducing mode, the pressure-increasing mode, and the pressure-holding mode. The pressure-reducing mode is to communicate between the servo chamber 10c and the reservoir chamber. The pressure-increasing mode is to communicate between the servo chamber 10c and the accumulator 61. The pressure-holding mode is to hermetically close the servo chamber 10c. The brake actuating member 71 is disposed behind the master cylinder. The braking effort, as produced by the driver of the vehicle, is transmitted to the brake actuating member 71. The input piston 15 is disposed behind the spool valve to be slidable within the cylindrical cavity 11p of the master cylinder 11. The input piston 15 connects with the brake actuating member 71 and is moved in response to the braking effort transmitted from the brake actuating member 71 to drive the spool valve. The braking simulator member (i.e., the simulator spring 26) is disposed ahead of the input piston 15 within the cylindrical cavity 11p of the master cylinder 11. The braking simulator member works to urge the input piston 15 rearward.

The brake system B may also include the brake sensor 72, the regenerative braking system A, and the movable member 32. The brake sensor 72 works to determine the degree of the braking effort applied to the brake actuating member 71. The regenerative braking system A serves to make the wheel Wfl, Wfr, Wrl, or Wrr create the regenerative force based on the braking effort, as determined by the brake sensor 72. The movable member 32 is disposed behind the spool valve at a given distance away from the spool valve to be movable within the cylindrical cavity 11p of the master cylinder 11. The braking simulator member (i.e., the simulator spring 26) is disposed between the movable member 32 and the input piston 15.

The brake system B also has the pressure regulator 53 works to increase or decrease the pressure of the brake fluid delivered from the master chambers 10a and 10b to the friction braking device Bfl, Bfr, Brl, or Brr as a function of the braking effort, as determined by the brake sensor 72.

The brake system B may also include the fail-safe cylinder 12, the fail-safe spring 36, and the operating rod 16.

The fail-safe cylinder 12 is disposed behind the master piston to be slidable within the cylindrical cavity of the master cylinder. The fail-safe cylinder 12 includes the first cylindrical portion 12b and the second cylindrical portion 12c disposed behind the first cylindrical portion 12b. The second cylindrical portion 12c is greater in outer diameter than the first cylindrical portion 12b. The fail-safe spring 36 works to urge the fail-safe cylinder 12 toward the front of the master cylinder 11. The operating rod 16 transmits the braking effort from the brake actuating member 71 to the input piston 15.

The input piston 15 is slidable in the fail-safe cylinder 12 in the longitudinal direction thereof. The master cylinder has a supply port (i.e., the fifth port 11f) which opens to the outer periphery of the first cylindrical portion 12b and to which the brake fluid is supplied from the accumulator 61. The master cylinder 11 and the fail-safe cylinder 12 have reservoir flow paths (i.e., the seventh port 11h and the fourth inner ports 12g) formed therein. The reservoir flow paths establish fluid communication between the reservoir 19 and a fluid chamber (i.e., the simulator chamber 10f) that is a portion of the cylindrical cavity 11p and defined ahead the input piston 15 inside the fail-safe cylinder 12 when the fail-safe cylinder 12 is in a rearmost position in a given allowable range.

When the brake fluid is being supplied from the accumulator 61 to the supply port (i.e., the fifth 11f), force, as developed by pressure of the brake fluid and a difference in traverse cross-section between the first cylindrical portion 21b and the second cylindrical portion 12c, presses the fail-safe cylinder 12 rearward in the master cylinder 11 to place the fail-safe cylinder 12 at the rearmost position.

When the brake fluid is not being supplied from the accumulator 61 to the supply port, the fail-safe cylinder 12 is urged by the fail-safe spring 36 frontward to block the reservoir flow path to hermetically close the fluid chamber defined ahead the input piston inside the fail-safe cylinder 12, thereby allowing the fail-safe cylinder 12 to press the master piston in response to the braking effort transmitted to the input piston 15.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

What is claimed is:

1. A braking device for a vehicle comprising:
a hydraulic pressure generator which includes a master cylinder which has a given length with a front and a rear and in which a master piston and an input piston are disposed, the master cylinder having formed therein a master chamber in which the master piston is moved within the master cylinder in response to an operation on a brake actuating member to develop pressure of brake fluid;
a servo unit which works to develop a hydraulic pressure within a servo chamber as a function of the operation on the brake actuating member and exert force on the master piston as a function of the hydraulic pressure in the servo chamber;
a wheel cylinder to which the pressure of the brake fluid is delivered from the master chamber to develop a frictional braking force to brake a vehicle;
an operating rod which has a front portion and a rear portion, the front portion being closer to the front of the master cylinder than the rear portion is, the operating rod working to transmit a braking effort, as applied to the brake actuating member, to the input piston disposed in the master cylinder;
a first spring retainer which is of a hollow cylindrical shape and disposed around the front portion of the operating rod and away from an outer periphery of the operating rod;
a second spring retainer which is of a hollow cylindrical shape and disposed around an outer periphery of the rear portion of the operating rod;
a return spring which is disposed between the first spring retainer and the second spring retainer, the return spring urging the first spring retainer in a frontward direction of the master cylinder and also urging the second spring retainer in a rearward direction of the master cylinder;
a movable member which moves following the operation on the brake actuating member in one of a forward direction in which the movable member approaches the front of the master cylinder and a backward direction in which the movable member travels away from the front of the master cylinder;
an outer peripheral member which is disposed around an outer periphery of the movable member to be stationary relative to the movable member; and
an elastic member which is of a hollow cylindrical shape and installed between the movable member and the outer peripheral member to seal therebetween,
wherein the servo unit is actuated following movement of the movable member to develop the hydraulic pressure within the servo chamber, and
wherein the elastic member works to create resistance to the movement of the movable member relative to the outer peripheral member and change the resistance following the movement of the movable member, so that the resistance is different between when the movable member moves in the frontward direction and when the movable member moves in the backward direction.

2. A braking device as set forth in claim 1, wherein one of an outer peripheral surface of the movable member and an inner peripheral surface of the outer peripheral member has formed therein a recess in which the elastic member is disposed, and wherein one of a bottom surface of the recess, the outer peripheral surface of the movable member and the inner peripheral surface of the outer peripheral member has a slant surface.

3. A braking device as set forth in claim 2, wherein the slant surface is inclined toward the front of the master cylinder outwardly or inwardly in a radial direction of a corresponding one of the movable member and the outer peripheral member.

4. A braking device as set forth in claim 2, wherein the movable member includes a first movable member, as defined by a front portion thereof closer to the front of the master cylinder, and a second movable member, as defined by a rear portion thereof farther away from the front of the master cylinder, and wherein the elastic member is disposed between the first and second movable member so as to create an air gap therebetween.

5. A braking device as set forth in claim 1, further comprising a second elastic member disposed between the operating rod and the outer peripheral member, the second elastic member being of a hollow cylindrical shape and having a front end closer to the front of the master cylinder and a rear end opposed to the first end, wherein the second elastic member has a protrusion which extends from the front end thereof frontward and inward in a radial direction of the outer peripheral member or rearward and inward in the radial direction of the outer peripheral member, and wherein the second elastic member working to press an outer periphery of the operating rod inwardly in a radial direction of the operating rod to achieve coincidence between center axes of the operating rod and the first spring retainer.

6. A braking device as set forth in claim 1, further comprising a boot which covers the operating rod and a rear opening of the master cylinder, the boot including a rear stationary portion which is made of an elastic material and presses an outer periphery of the second spring retainer, the rear stationary portion having a plurality of protrusions placed in contact with the outer periphery of the second spring retainer.

7. A braking device for a vehicle comprising:
a hydraulic pressure generator which includes a master cylinder which has a given length with a front and a rear and in which a master piston and an input piston are disposed, the master cylinder having formed therein a master chamber in which the master piston is moved within the master cylinder in response to an operation on a brake actuating member to develop pressure of brake fluid;
a servo unit which works to develop a hydraulic pressure within a servo chamber as a function of the operation on the brake actuating member and exert force on the master piston as a function of the hydraulic pressure in the servo chamber;
a wheel cylinder to which the pressure of the brake fluid is delivered from the master chamber to develop a frictional braking force to brake a vehicle;
an operating rod which has a front portion and a rear portion, the front portion being closer to the front of the master cylinder than the rear portion is, the operating rod working to transmit a braking effort, as applied to the brake actuating member, to the input piston disposed in the master cylinder;
a first spring retainer which is of a hollow cylindrical shape and disposed around the front portion of the operating rod and away from an outer periphery of the operating rod;
a second spring retainer which is of a hollow cylindrical shape and disposed around an outer periphery of the rear portion of the operating rod;
a return spring which is disposed between the first spring retainer and the second spring retainer, the return spring urging the first spring retainer in a frontward direction of the master cylinder and also urging the second spring retainer in a rearward direction of the master cylinder;
an outer peripheral member which is disposed around an outer periphery of the operating rod to be stationary relative to the operating rod; and
a hollow cylindrical elastic member disposed between the operating rod and the outer peripheral member, the elastic member having a front end closer to the front of the master cylinder and a rear end opposed to the first end, the elastic member having a protrusion which extends from the front end thereof frontward and inward in a radial direction of the outer peripheral member or rearward and inward in the radial direction of the outer peripheral member, the elastic member working to press the outer periphery of the operating rod inwardly in a radial direction of the operating rod to achieve coincidence between center axes of the operating rod and the first spring retainer.

8. A braking device as set forth in claim 7, further comprising a boot which covers the operating rod and a rear opening of the master cylinder, the boot including a rear stationary portion which is made of an elastic material and presses an outer periphery of the second spring retainer, the rear stationary portion having a plurality of protrusions placed in contact with the outer periphery of the second spring retainer.

9. A braking device for a vehicle comprising:
a hydraulic pressure generator which includes a master cylinder which has a given length with a front and a rear and in which a master piston and an input piston are disposed, the master cylinder having formed therein a master chamber in which the master piston is moved within the master cylinder in response to an operation on a brake actuating member to develop pressure of brake fluid;
a servo unit which works to develop a hydraulic pressure within a servo chamber as a function of the operation on the brake actuating member and exert force on the master piston as a function of the hydraulic pressure in the servo chamber;
a wheel cylinder to which the pressure of the brake fluid is delivered from the master chamber to develop a frictional braking force to brake a vehicle;
an operating rod which has a front portion and a rear portion, the front portion being closer to the front of the master cylinder than the rear portion is, the operating rod working to transmit a braking effort, as applied to the brake actuating member, to the input piston disposed in the master cylinder;
a first spring retainer which is of a hollow cylindrical shape and disposed around the front portion of the operating rod and away from an outer periphery of the operating rod;
a second spring retainer which is of a hollow cylindrical shape and disposed around an outer periphery of the rear portion of the operating rod;
a return spring which is disposed between the first spring retainer and the second spring retainer, the return spring urging the first spring retainer in a frontward direction of the master cylinder and also urging the second spring retainer in a rearward direction of the master cylinder; and
a boot which covers the operating rod and a rear opening of the master cylinder, the boot including a rear stationary portion which is made of an elastic material and presses an outer periphery of the second spring retainer, the rear stationary portion having a plurality of protrusions placed in contact with the outer periphery of the second spring retainer.
